(19) United States
(12) Patent Application Publication
(10) Pub. No.: US 2021/0167946 A1
(43) Pub. Date: Jun. 3, 2021

(54) One-Round Secure Multiparty Computation of Arithmetic Streams and Evaluation of Functions

(71) Applicant: B. G. NEGEV TECHNOLOGIES & APPLICATIONS LTD., AT BEN-GURION, Beer Sheva (IL)

(72) Inventors: Dor Bitan, Lehavim (IL); Daniel Berend, Beer Sheva (IL); Shlomi Dolev, Omer (IL)

(21) Appl. No.: 17/047,878

(22) PCT Filed: Apr. 14, 2019
(86) PCT No.: PCT/IL2019/050420

§ 371 Date: Oct. 15, 2020

Related U.S. Application Data
(60) Provisional application No. 62/700,351, filed on Jul. 19, 2018.
(60) Provisional application No. 62/658,624, filed on Apr. 17, 2018.

(51) Int. Cl. H04L 9/08

(52) U.S. Cl. CPC H04L 9/085; H04L 9/008; H04L 2209/46

(57) ABSTRACT

A method for performing, in a single round of communication and by a distributed computational system, Secure MultiParty Computation (SMPC) of an arithmetic function ƒ: [symbol] ₚ^{k}→ [symbol] ₚ represented as a multivariate polynomial over secret shares for a user, comprising the steps of sharing secrets among participants being distributed computerized systems, using multiplicative shares, the product of which is the secret, or additive shares, that sum up to the secret by partitioning secrets to sums or products of random elements of the field; implementing sequences of additions of secrets locally by addition of local shares or sequences of multiplications of secrets locally by multiplication of local shares; separately evaluating the monomials of ƒ by the participants; adding the monomials to obtain secret shares of ƒ.

### FIELD OF INVENTION

The present invention relates to the field of distributed computation. More specifically, the present invention relates to a system and method for performing secure multiparty computation of arithmetic streams and evaluation of functions in a single round of communication.

### BACKGROUND OF THE INVENTION

Cloud services for storage and computing has significant benefits in price, speed, and manageability and therefore, became very popular. Companies like Amazon, Google, Microsoft, IBM, etc., are offering storage devices and computing engines to both private users and organizations. However, such services require users to send their information to an untrusted third party. In some cases, the information held by a user is confidential and the distribution of the information to untrusted parties should be avoided.

One existing solution to this problem may be a cryptographic scheme that enables a user to upload encrypted data to the cloud, perform computations in the cloud over the encrypted data and retrieve the encrypted version of the desired result, as shown in FIG. 1 (prior art). Such an encryption scheme enables the user to take advantage of the storage and computing power provided by the cloud without compromising the confidentiality of the data.

Other existing solutions are Secure MultiParty Computation (SMPC) schemes over a distributed system, as shown in FIG. 2 (prior art). These schemes are information-theoretically secure and support such computations at the cost of communication between participants. At each round of communication, each participant sends at most one message to each of the other participants, performs arbitrary computations and/or receives at most one message from each of the other participants (not necessarily in this order). Typically, communication between participants is used for reducing the degree of the polynomial that encrypts the data after each multiplication during the computation.

Other existing solutions are fully homomorphic encryption schemes, which suggest a centralized (rather than distributed) computationally secure solutions to the above mentioned problem. However, these solutions are only computationally secure (rather than information-theoretically secure) and are currently too slow to be used in practice.

Ben-Or, Goldwasser and Wigderson [BOGW88] showed that every function of N inputs can be efficiently computed by N participants with a threshold of N/2 in case of honest-but-curious participants, or N/3 in case of malicious participants. Their methods are based on Shamir's secret sharing scheme [Sha79] and their protocols require multiple rounds of communication, proportional to the depth of the arithmetic circuit. Substantial efforts have been spent to achieve a better communication complexity in such tasks. Bar-Ilan and Beaver [BIB89] were the first to suggest a way to evaluate functions in a constant number of rounds of communication, followed by further works that attempt to minimize communication complexity of SMPC protocols. Gennaro, Ishai, Kushilevitz and Rabin [GIKR02] proved that, in the presence of malicious participants, some functions do not admit SMPC protocols with less than three rounds of communication. Specifically, they have shown that the functions XOR₂ⁿ and AND₂ⁿ do not admit protocols of SMPC with only two rounds of communication, while assuming that malicious participants are present. Nonetheless, they have shown that functions that depend only on the inputs of a single participant can be securely computed in two rounds of communication. When relaxing the assumptions and considering honest-but-curious participants, the round complexity of general SMPC protocols is reduced to two rounds of communication [BOGW88,IK02].

It is therefore an object of present invention to provide a method and system for performing secure multiparty computation of arithmetic streams and functions, which requires one-round of communication.

It is another object of the present invention to provide a method and system for performing secure multiparty computation of arithmetic streams and functions, without decrypting the secrets during the course of the computation.

It is a further object of the present invention to provide a method and system for performing secure multiparty computation of arithmetic streams and functions, which is information-theoretically secure with a threshold of all active participants.

It is still another object of the present invention to provide a method and system for performing secure multiparty computation of arithmetic streams and functions, which can support boolean circuits.

It is yet another object of the present invention to provide a method and system for performing secure multiparty computation of arithmetic streams and functions, which is not saved as plaintext anywhere and keeps the computation state of the stream secure at all times.

Other objects and advantages of this invention will become apparent as the description proceeds.

### SUMMARY OF THE INVENTION

A method for performing, in a single round of communication and by a distributed computational system, Secure MultiParty Computation (SMPC) of an arithmetic function ƒ: [symbol] ₚ^{k}→ [symbol] ₚ represented as a multivariate polynomial over secret shares for a user, comprising the steps of:
a. sharing secrets among participants being distributed computerized systems, using multiplicative shares, the product of which is the secret, or additive shares, that sum up to the secret by partitioning secrets to sums or products of random elements of the field;
b. implementing sequences of additions of secrets locally by addition of local shares or sequences of multiplications of secrets locally by multiplication of local shares; and
c. separately evaluating the monomials of ƒ by the participants; and
d. adding the monomials to obtain secret shares of ƒ.
In one aspect, two sets of participants are used by a dealer to securely outsource a computation of an arithmetic stream by:
a. providing a first set of participants consists of n₁ M.parties, that locally handle sequences of multiplications;
b. providing a second set consists of n₂ A.parties that locally handle sequences of additions;
c. switching from sequences of multiplications to sequences of additions and vice versa without decrypting the information;
d. eliminating the previous sets whenever there is a switch between sequences of multiplications to sequences of additions.

A method for performing, by a distributed computational system, Secure MultiParty Computation (SMPC) of a function ƒ: [symbol] ^{k}→ [symbol] over k non-zero elements S=(s₁, . . . , sₖ)∈ [symbol] ^{k}, where the minimal multivariate polynomial representation of ƒ is

ƒ(x₁, . . . ,xₖ)=Σₗ₌₍ₗ_{₀}_{, . . . ,l}_{ₖ}_{)∈} [symbol] l₀·x₁^{l}^{₁} . . . xₖ^{l}^{ₖ}, [symbol] ={0,1, . . . }^{k+1}
over secret shares for a user, comprising the steps of:
a. providing k non-zero elements S=(s₁, . . . , sₖ)∈ [symbol] ^{k} of the user;
b. providing n honest-but-curious participants, [symbol] ⁽¹⁾, . . . , [symbol] ⁽ⁿ⁾ belonging to the distributed computational system and having a private connection channel with then honest-but-curious participants, [symbol] ⁽¹⁾, . . . , [symbol] ⁽ⁿ⁾;
c. for sⱼ, 1≤j≤k, performing mult.-random-split of sⱼ to multiplicative shares, mᵢⱼ, such that sⱼ=Πᵢ₌₁ⁿ mᵢⱼ;
d. distributing mᵢⱼ to [symbol] ⁽ⁱ⁾;
e. evaluating the monomials of ƒ separately by the participants and adding the monomials to obtain secret shares of ƒ(s₁, . . . , sₖ), where for l∈ [symbol] , the l'th monomial is l₀·x₁^{l}^{₁} . . . xₖ^{l}^{ₖ}; and
f. for each l, calculating additive shares such Uᵢ of the l'th monomial of ƒ evaluated on S, such that each participant [symbol] ⁽ⁱ⁾ obtains such Uᵢ for each of the monomials of ƒ.

A method for performing, by a distributed computational system, Secure MultiParty Computation (SMPC) of a p-bounded arithmetic function ƒ: [symbol] ₚ^{k}→ [symbol] ₚ over k elements S=(s₁, . . . , sₖ)∈ [symbol] ₚ^{k}, where the minimal multivariate polynomial representation of ƒ is

ƒ(x₁, . . . ,xₖ)=Σₗ₌₍ₗ_{₀}_{, . . . ,l}_{ₖ}_{)∈} [symbol] l₀·x₁^{l}^{₁} . . . xₖ^{l}^{ₖ}, [symbol] ={0, . . . ,p−1}^{k+1}
over secret shares for a user, comprising the steps of:
a. providing k elements S=(s₁, . . . , sₖ)∈ [symbol] ₚ^{k} of the user;
b. providing n honest-but-curious participants, [symbol] ⁽¹⁾, . . . , [symbol] ⁽ⁿ⁾ belonging to the distributed computational system and having a private connection channel with then honest-but-curious participants, [symbol] ⁽¹⁾, . . . , [symbol] ⁽ⁿ⁾;
c. for sⱼ, 1≤j≤k, performing mult.-random-split of sⱼ to multiplicative shares, mᵢⱼ, such that sⱼ=Πᵢ₌₁ⁿ mᵢⱼ;
d. distributing mᵢⱼ to [symbol] ⁽ⁱ⁾;
e. evaluating the monomials of ƒ separately by the participants and adding the monomials to obtain secret shares of ƒ(s₁, . . . , sₖ), where for l∈ [symbol] , the l'th monomial is l₀·x₁^{l}^{₁} . . . xₖ^{l}^{ₖ}; and
f. for each l, calculating additive shares such Uᵢ of the l'th monomial of ƒ evaluated on S, such that each participant [symbol] ⁽ⁱ⁾ obtains such U, for each of the monomials of ƒ.

The l'th monomial may be evaluated by:
a. sending l to the participants;
b. performing matrix-random-split of 1 to C∈Mₙ( [symbol] ₚ) according to the following steps:
   b.1) perform add.-random-split of 1∈ [symbol] ₚ to γ₁+ . . . +γₙ.
   for 1≤i≤n:
   b.2) choose uniformly at random n−1 non-zero elements of [symbol] ₚ, cᵢⱼ, for 1≤j≤n, j≠i;
   b.3) set cᵢᵢ=γᵢ/δ where δ=c_{i,1} . . . c_{i,j-1}·c_{i,j+1} . . . c_{i,n};
   b.4) distribute to each [symbol] ⁽ⁱ⁾ the i'th column [C]ᵢ of C., where C=(cᵢⱼ)_{i,j=1}ⁿ∈Mₙ( [symbol] ₚ).
   b.5) each [symbol] ⁽ⁱ⁾ computes the alpha vector αᵢ of participant [symbol] ⁽ⁱ⁾;
   b.6) for 1≤i≤n, each of the participants sends the i'th entry of the alpha vector, computed in the previous stage, to [symbol] ⁽ⁱ⁾; and
   b.7) each of the participants multiplies the values received in the previous stage and computes:

Uᵢ=l₀·(α₁)ᵢ· . . . ·(αₙ)ᵢ.

In one aspect, the method further comprises the step of adding additive shares of two functions that ƒ₁ and ƒ₂ evaluated on S, held by the participants to obtain additive shares of ƒ₁(S)+ƒ₂(S).

In one aspect, the methods further comprises the step of calculating a linear combination if additive shares of an arbitrary number of functions ƒ₁, . . . , ƒ_{d} evaluated on S, to obtain additive shares of ƒ₁(S)+ƒ₂(S)+ . . . +ƒ_{d}(S).

The SMPC of the product ƒ(S)·l₀·s₁^{l}^{₁} . . . sₖ^{l}^{ₖ} for a given l may be performed by generating a matrix-random-split of ƒ(S) using the additive shares of ƒ(S) held by the participants.

Additive shares of the product ƒ(S)·l₀·s₁^{l}^{₁} . . . sₖ^{l}^{ₖ} may be held by the participants, by:
a. allowing each participant [symbol] ⁽ⁱ⁾ to perform mult.-random-split of γᵢ to cᵢ₁· . . . ·cᵢₙ, where γ₁, . . . , γₙ are the additive shares of ƒ(S) held by the participants at the end of the evaluation procedure and the cᵢⱼ's constitute a matrix-random-split of ƒ(S);
b. allowing each participant [symbol] ⁽ⁱ⁾ to distribute the multiplicative shares of its additive share of ƒ(S) to the other participants in a way that each participant [symbol] ⁽ⁱ⁾ receives the i'th column of C.

Switching from multiplicative shares of s to additive shares of sⱼ is implemented using evaluation to perform SMPC of the function ƒ(x₁, . . . , xₖ)=sⱼ and switching from additive shares of sⱼ to multiplicative shares of sⱼ is implemented e for computing a product ƒ(S)·l₀·s₁^{l}^{₁} . . . sₖ^{l}^{ₖ}.

In one aspect, some of the secret shares are zero.

The number of participants may be extended to n₁ M.parties+n₂ A.parties (n₁, n₂≥2) by:
a. taking n₁−1 random non-zero elements of the field, x₁, . . . , xₙ_{₁}₋₁; computing the xₙ_{₁} that yields øᵢ₌₁ⁿ^{₁} xᵢ=m; and
b. taking n₂−1 random non-zero elements of the field, x₁, . . . , xₙ_{₂}₋₁; computing the xₙ_{₂} that yields Σᵢ₌₁ⁿ^{₂} xᵢ=m.

Additive shares of the secret shared data may be produced from multiplicative shares of the secret shared data by shifting information from n₁ M.parties to n₂ A.parties according to the following steps:
a. if n₁ M.parties, [symbol] ⁽ⁱ⁾, 1≤i≤n₁, hold n₁ multiplicative shares, xᵢ, of an element m, to achieve n₂ additive shares of m held by n₂ A.parties, splitting x₁ to n₂ additive shares bⱼ, 1≤j≤n₂ by [symbol] ⁽¹⁾ add.-random;
b. sending each bⱼ to the j'th A.party;
c. sending xᵢ to each of the A.parties by the rest of the M.parties, [symbol] ⁽ⁱ⁾, 2≤i≤n₁;
d. eliminating the M.parties;
e. multiplying the received values by the A.parties, to obtain additive shares of m.
where,

m=Πᵢ₌₁ⁿ^{₁}xᵢ=x₁·Πᵢ₌₂ⁿ^{₁}xᵢ=(Σⱼ₌₁ⁿ^{₂}bⱼ)·Πᵢ₌₂ⁿ^{₁}xᵢ=Πᵢ₌₁ⁿ^{₂}(bⱼ·Πᵢ₌₂ⁿ^{₁}xᵢ).

Multiplicative shares of the secret shared data may be produced from additive shares of the secret shared data by shifting information from n₂ A.parties to n₁ M.parties according to the following steps:
a. if n₂ A.parties, [symbol] ⁽ⁱ⁾, 1≤i≤n₂, hold n₂ additive shares, xᵢ, of an element m, obtain n₁ multiplicative shares of m held by n₁ M.parties, splitting 1 to n₁ multiplicative shares by mult.-random;
b. sending n₁−1 M.parties one (distinct) multiplicative share of 1;
c. sending the last share of 1 to all of the A.parties;
d. multiplying, by each of the A.parties, the multiplicative share of 1 received by its additive share of m;
e. sending the product to the last M.party;
f. eliminating the A.parties; and
g. adding the values received by the last M.party, such that the M.parties hold multiplicative shares of m.

Secure MultiParty Computation (SMPC) of Boolean circuits may be computed by working in [symbol] ₂.

Secure MultiParty Computation (SMPC) of arithmetic functions over inputs held by k users [symbol] ⁽¹⁾, . . . , [symbol] ^{(k)}, each of whom is holding a set of secret values in [symbol] ₚ, may be performed by the following steps:

a. each of the users distributes shares of his secrets;

b. one of the users sends the relevant information to the other participants;

c. the participants send their outputs to all of the users; and

d. each of the users obtains the result of evaluating ƒ over the entire set of secrets by adding the outputs.

Arithmetic streams may be secured by performing, at each stage of computation, both addition and multiplication operations that yield the same result that are obtained by one of the operations.

If the information held by the user is m=(m₁, . . . , mₙ)∈ [symbol] ₚⁿ, an arithmetic function ƒ may be secured by the following steps:
a. taking redundant copies of each (or some) of the mᵢ's;
b. taking redundant variables that equal 1∈ [symbol] ₚ,
c. taking redundant variables that equal 0∈ [symbol] ₚ;
d. permute them all to obtain m′=(m′₁, . . . , m′ᵣ) which contains the information began with, along the added redundancy; and
e. evaluating ƒ: [symbol] ₚⁿ→ [symbol] ₚ over m by taking a suitable ƒ′: [symbol] ₚ^{r}→ [symbol] ₚ and evaluating ƒ′ over m′ such that ƒ(m)=ƒ′(m′), where ƒ(m)= [symbol] aᵢ·Aᵢ, aᵢ∈ [symbol] ₚ, and Aᵢ is the i'th monomial.

In one aspect, the method further comprises the step of detecting incorrect outputs caused by malicious participants by repeating the same computations while using different sets of participants.

In one aspect, the method further comprises the step of detecting incorrect outputs caused by malicious participants by computing different representations of the same function.

In one aspect, the method further comprises the step of detecting incorrect outputs caused by malicious participants by computing the same circuit several times using the same n participants with different randomization in each computation and different representations of the same circuit in each iteration.

Functions may be evaluated over inputs being held by all of the participant.

In one aspect, the user may be one of the participants.

A computerized system for performing, in a single round of communication and by a distributed computational system, Secure MultiParty Computation (SMPC) of an arithmetic function ƒ: [symbol] ₚ^{k}→ [symbol] ₚ represented as a multivariate polynomial over secret shares for a user, comprising:
a. at least one processor, adapted to:
   a.1) share secrets among participants being distributed interconnected computerized systems, using multiplicative shares, the product of which is the secret, or additive shares, that sum up to the secret by partitioning secrets to sums or products of random elements of the field;
   a.2) implementing sequences of additions of secrets locally by addition of local shares or sequences of multiplications of secrets locally by multiplication of local shares; and
   a.3) evaluating the monomials of ƒ by the participants separately; and
   a.4) add the monomials to obtain secret shares of ƒ; and
b. a plurality of private connection channels between each participant and the user, for securely exchanging encrypted data consisting of a combination of secret shares.

### BRIEF DESCRIPTION OF THE DRAWINGS

In the drawings:

FIG. 1 (prior art) shows a cryptographic scheme that enables a user to upload encrypted data to the cloud, perform computations in the cloud over the encrypted data and retrieve the encrypted version of the desired result;

as shown in FIG. 2 (prior art) a Secure MultiParty Computation (SMPC) scheme over a distributed system;

FIG. 3 illustrates an example of performing multiplications by splitting the information between two parties [symbol] ⁽¹⁾ and [symbol] ⁽²⁾ in multiplication mode, according to an embodiment of the invention;

FIG. 4 illustrates an example of switching from multiplication mode to addition mode, according to an embodiment of the invention;

FIG. 5 illustrates an example of performing additions by splitting the information between two parties [symbol] ⁽¹⁾ and [symbol] ⁽²⁾ in addition mode, according to an embodiment of the invention;

FIG. 6 illustrates an example of switching from addition mode to multiplication mode, according to an embodiment of the invention;

FIG. 7 illustrates an example of a distribution protocol, which is invoked by the user to secret share m=(m₁, . . . , mₙ)∈ [symbol] ₚⁿ amongst the M.parties;

FIG. 8 illustrates an example of Shifting from the M.parties to A.parties, while eliminating the M.parties, and the A.parties multiply the values received;

FIG. 9 illustrates an example of performing mult.-random-split of 1∈ [symbol] ₚ to two multiplicative shares xₘ₊₁ and r, and sending xₘ₊₁ to [symbol] ⁽¹⁾ and r to the A.parties. Each of the A.parties multiplies r by uₖ, k=3,4, and sends the product to [symbol] ⁽²⁾, while eliminating the A.parties;

FIG. 10 illustrates an example of distribution, where perform mult.-random-split of sⱼ to multiplicative shares, mᵢⱼ is performed, such that sⱼ=Πᵢ₌₁ⁿ mᵢⱼ and distribute mᵢⱼ to [symbol] ⁽ⁱ⁾;

FIG. 11 illustrates stages 2 and 3 of the evaluation process for each monomial;

FIG. 12 illustrates an example of distribution of information between millionaires wish to find out who of them is the wealthiest, while not revealing to each other the exact number of millions they possess; and

FIG. 13 illustrates a system for performing distribution for sⱼ, 1≤j≤k, by performing mult.-random-split of sⱼ to multiplicative shares, mᵢⱼ, among n participants [symbol] ⁽¹⁾, . . . , [symbol] ⁽ⁿ⁾.

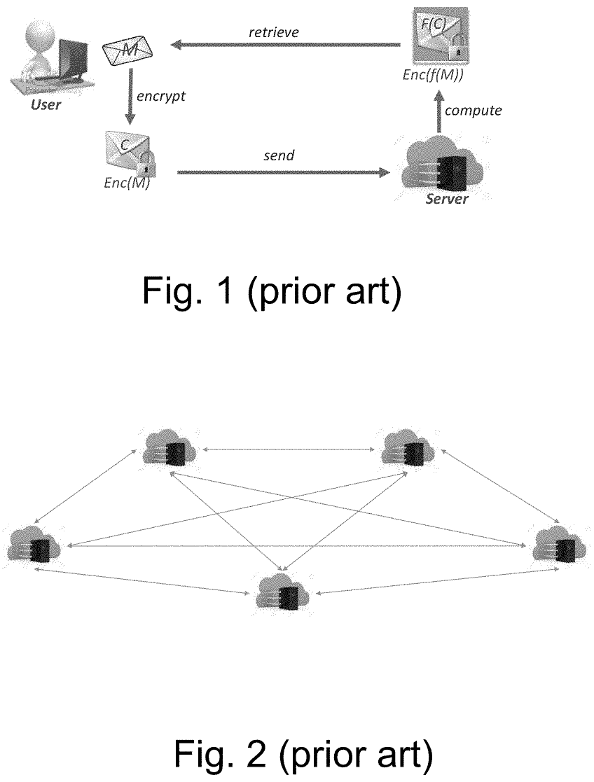

### DETAILED DESCRIPTION OF THE INVENTION

The present invention proposes efficient Secure MultiParty Computation (SMPC) schemes over secret shares in scenarios in which the secrets are elements of a finite field [symbol] ₚ, which are information-theoretically secure with a threshold of all active participants. Any function ƒ: [symbol] ₚⁿ→ [symbol] ₚ is represented as a multivariate polynomial and the evaluation of ƒ is implemented in a single round of communication. The proposed SMPC schemes are based on partitioning secrets to sums or products of random elements of, [symbol] ₚ. Secrets are shared using either multiplicative shares, the product of which is the secret, or additive shares, that sum up to the secret. Sequences of additions of secrets are implemented locally by addition of local shares, which require no communication among participants. Sequences of multiplications of secrets are implemented locally by multiplication of local shares, which require no communication among participants. The shift to handle a sequence of additions from the execution of multiplications or vice versa is efficiently handled as well, with no need to decrypt the secrets in the course of the computation. The proposed schemes can also be used to support SMPC of boolean circuits (that perform boolean commutation, rather than arithmetic).

The present invention proposes several schemes for information-theoretically SMPC of arithmetic streams and for evaluation of arithmetic functions in a single round of communication.

In a first exemplary schemes for SMPC of arithmetic streams, two sets of participants are used by a dealer to securely outsource a computation of an arithmetic stream. The first set of participants consists of n₁ M.parties, that locally handle sequences of multiplications, and the second set consists of n₂ A.parties that locally handle sequences of additions. Switching from sequences of multiplications to sequences of additions and vice versa are made without decrypting the information. These schemes require the user to perform, practically, as much computational work as he would have needed to if computing the arithmetic stream on his hardware. The main purpose of these schemes is to keep the computation state of the stream secure at all time, not saved as plaintext anywhere.

These schemes are composed of (a) two procedures that enable computations in each mode; (b) two procedures that are used to switch between modes. These procedures give rise to SMPC schemes for evaluation of arithmetic functions in one round of communication. Since over finite fields every function may be written as a polynomial, these procedures may be used to outsource storage of information to untrusted participants (honest-but-curious) while allowing outsourcing of computations over the distributed data.

These schemes use two sets of participants and require the elimination of the previous set whenever there is a switch between modes. That need for ongoing elimination of participants is solved by presenting schemes for SMPC of arithmetic functions using one set of n participants for both operations. This solution costs in communication complexity in the following way. In the schemes proposed for stream computation and for SMPC of arithmetic functions in one round of communication, the procedures M→A and SMA require sending a total of n₁·n₂ messages between the participants. The procedures A→M or Cascading require sending a total amount of 2n₂+n₁−1 messages between the participants.

In the schemes for handling both operations by the same participants, in each round of communication the number of messages sent between participants is n².

The present invention proposes two pairs of schemes for outsourcing arithmetic computations in a finite field, [symbol] ₚ. The first pair of schemes assumes that the computation state or the distributed values are non-vanishing in the field. The second pair of schemes solves the case where the mentioned values may vanish in [symbol] ₚ by embedding [symbol] ₚ in [symbol] _{q} (for large enough q). Such a q always exists. However, for some functions/streams, the resulting scheme is impractical since q is too large to work with. The schemes for the non-vanishing case are practical whenever the polynomial representation of the function is not too large to work with.

The proposed schemes allow evaluation of any arithmetic function in exactly one round of communication, assuming that the participants are honest-but-curious. This approach is based on representing each secret either as a sum of secret shares or as a product of secret shares, while shifting between representations when necessary. In schemes that use two sets of participants, at each stage, only one of the sets holds shares of the secrets. The participants in the first set handle multiplications and are called the multiplication participants, or the M.parties. The participants in the second set handle additions and are called the addition participants, or the A.parties.

The operations of the participants in a sequence of the same operation and the communication between them when there is a switch in operations and the immediate elimination of the previous participants (virtual machines, containers, etc.), are described. These schemes require communication among participants only when switching between operations, and support communicationless sequences of multiplications followed by communicationless sequences of additions and vice versa. These schemes are information-theoretically secure against attacks of coalitions that consist of all-but-one of the active participants.

The main ideas used to construct these two-set schemes give rise to a scheme that uses only one set of participants and allows evaluation of arithmetic functions in one round of communication.

### Example of Stream Computation

a user receives a stream of values and arithmetic operations produced by some source and wishes to perform an arithmetic computation over the values received according to the operations received on the fly. The stream begins with an initial value, denoted by m₀. At this stage, the user sets a value, referred to as the computation state and denoted by st, and initializes st as m₀. Afterward, at each stage, a pair of value and arithmetic operation are produced by the source and received by the user, who in turn updates the computation state st accordingly. Explicitly, at stage i (for i≥1) a pair, consisting of a value m, and arithmetic operation opᵢ are produced, where opᵢ is either addition ‘+’ or multiplication ‘·’. The user updates the state either by multiplying st by mᵢ or by adding mᵢ to st, according to opᵢ. Namely, st:=st opᵢ mᵢ.

It is assumed that the values received from the source are confidential, and so is the computation state that they yield at each stage. The user cannot keep (and update) st on his hardware, since it might be hacked by an adversary. Therefore, the desired cryptographic scheme is a cryptographic scheme that will allow the user to outsource the aforementioned computation, while keeping the values m, and st information-theoretically secure at all stages, without keeping st as plaintext at any stage. The value m, should also be eliminated at the end of each stage. The user should be able to retrieve st at any desired time.

Usually, outsourcing of computation considers a user that wishes to use a remote strong computer to run a computation over private data, where the main reason for outsourcing the computation is computing power. One of the main interests in such scenarios is to involve the user in the computation as little as possible and to shift most of the computational tasks to the cloud. Since the values are produced by the source and received by the user on-the-fly, the user must be on-line during the computation and take an active part in the computation. It is assumed that the user does have enough computing power to run the computation, but since the values and the computation state produced during computation are confidential, the user cannot save them as plaintext anywhere.

### Schemes for Outsourcing Stream Computations

### Scheme 1: A Non-Vanishing Stream

This scheme performs secure outsourcing of stream computation under the following assumptions. For the particular example detailed in the sequel, it is assumed that the values mᵢ are elements of the field [symbol] ₚ of prime order p (in which the arithmetic operations are carried out), and that the values and operations produced never yield st=0. Such a stream is non-vanishing. It is assumed that the user has a secure connection channel with (at least) four honest-but-curious (Honest-but-curious means that all parties follow the protocol honestly, and a protocol is private if any parties who collude at the end of the protocol learn nothing beyond their own outputs from their transcripts) servers denoted [symbol] ^{(j)} (for 1≤j≤4). The basic four participants scheme can be generalized to one with a larger number of participants. The scheme for the case of four participants is first presented. In this proposed scheme, some of the participants hold shares of the computation state st, denoted by st^{(j)}. The shares do not reveal any information about st and enable extrapolation of st by the user at any stage.

The proposed scheme has two modes: multiplication mode and addition mode. [symbol] ⁽¹⁾ and [symbol] ⁽²⁾ are the M.parties and the rest of the servers are the A.parties. The proposed scheme is consists of five procedures as follows:
Init—Initializing.
MinM—Multiplication in multiplication mode.
M→A—Switching mode from multiplication to addition.
AinA—Addition in addition mode.
A→M—Switching mode from addition to multiplication.

The general idea behind the scheme is that multiplications are handled by the M.parties and additions by the A.parties. At stage i, some of the procedures are invoked to update st according to opᵢ and shift (if necessary) the shares from one set of participants to another, while eliminating the previous set of participants. When the shares of st are being held by the M.parties (respectively, A.parties), it is determined that the scheme is in multiplication (respectively, addition) mode. When the shares of st are being held by the A.parties, it is determined that the scheme is in addition mode.

The scheme stages are as follows:
Run Init—distributing (multiplicative) shares of m₀ to [symbol] ⁽¹⁾ and [symbol] ⁽²⁾.
At stage i, upon receiving (mᵢ, opᵢ):
   If the received operation opᵢ does not match the current mode (i.e., receiving opᵢ=‘·’ in addition mode or opᵢ=‘+’ in multiplication mode), then run M→A or A→M to switch mode and eliminate the previous set of participants.
   Run AinA or MinM to update the shares of st according to (mᵢ, opᵢ).

All operations are carried out in [symbol] ₚ.

### Procedure 1: Init—Initializing

This procedure (called mult.-random-split of an element of [symbol] ₚ^{x} into two multiplicative shares) is invoked by the user and the M.parties only at stage zero, when the initial value m₀ is produced and received by the user. At the first step, the user picks a non-zero element x₀ of [symbol] ₚ uniformly at random and computes y₀, such that x₀·y₀=m₀. At the next step, the user sends x₀ to [symbol] ⁽¹⁾ and y₀ to [symbol] ⁽²⁾, who in turn set st⁽¹⁾ to x₀ and st⁽²⁾ to y₀, respectively. The values st⁽¹⁾ and st⁽²⁾, kept by the M.parties after the execution of this protocol, are their shares of st. Since x₀ is picked randomly, y₀ is also random. Hence, no information concerning m₀ is revealed to the M.parties.

### Procedure 2: MinM—Multiplication in Multiplication Mode

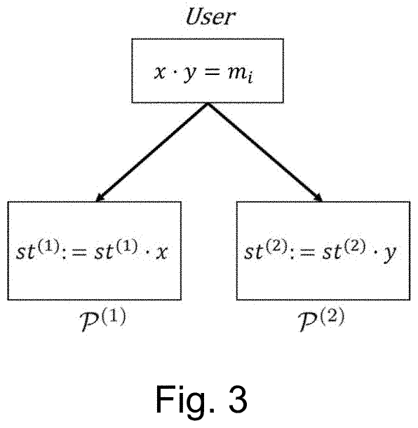

This procedure is invoked by the user and the M.parties at stages i such that opᵢ is multiplication (after switching to multiplication mode if necessary, using A→M). As described in FIG. 3, and similarly to Init, first the user mult.-random-splits mᵢ to x·y. Then the user sends x to [symbol] ⁽¹⁾ and y to [symbol] ⁽²⁾. The M.parties in turn update the shares of st they hold. [symbol] ⁽¹⁾ sets st⁽¹⁾ to st⁽¹⁾·x and [symbol] ⁽²⁾ sets st⁽²⁾ to st⁽²⁾·y. Now, the shares of the M.parties are updated according to the current computation state. The fact that x and y are random implies that no information is revealed to the participants neither about m, nor about st.

Procedure 3: M→A—Switching Mode from Multiplication to Addition

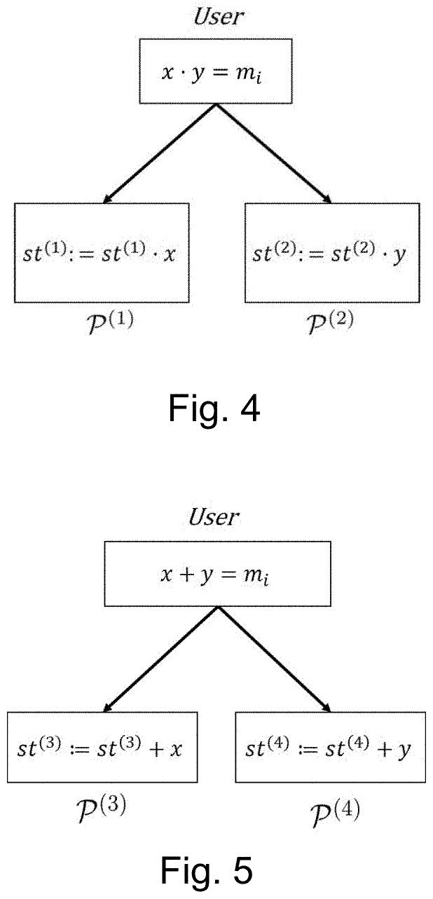

This procedure (called add.-random-split of an element of [symbol] ₚ into two additive shares, a and b) is invoked by all the participants at stages i such that opᵢ is addition and the current mode is multiplication: First, [symbol] ⁽¹⁾ picks an element a of [symbol] ₚ and computes b such that a+b=st⁽¹⁾. Then, as described in FIG. 4, [symbol] ⁽¹⁾ sends a to [symbol] ⁽³⁾ and b to [symbol] ⁽⁴⁾, while [symbol] ⁽²⁾ sends st⁽²⁾ to both [symbol] ⁽³⁾ and [symbol] ⁽⁴⁾. At this stage the M.parties are eliminated. Then, the A.parties multiply the values they received and set st^{(j)} (j=3,4) to the appropriate products.

In this case:

st=st⁽¹⁾·st⁽²⁾=(a+b)·st⁽²⁾=a·st⁽²⁾+b·st⁽²⁾=st⁽³⁾+st⁽⁴⁾.

Namely, from the two mult.-random-split shares of st that were held by the M.parties, the A.parties receive add.-random-split shares of st. Since a and b are random elements of the field, the A.parties gain no information about st and the M.parties are eliminated.

### Procedure 4: AinA —Adding in Addition Mode

This procedure is invoked by the user and the A.parties at stages i such that opᵢ is addition (after switching to addition mode if necessary, using M→A). As described in FIG. 5, the user add.random-splits mᵢ to x+y and sends x to [symbol] ⁽³⁾ and y to [symbol] ⁽⁴⁾. Then, in order to update its share of the computation state, each A.party adds the value it received from the user to st^{(j)}, (j=3,4). Since x and y are random elements of the field, neither of the A.parties gain any information about mᵢ or about the current state.

Procedure 5: A→M—Switching Mode from Addition to Multiplication.

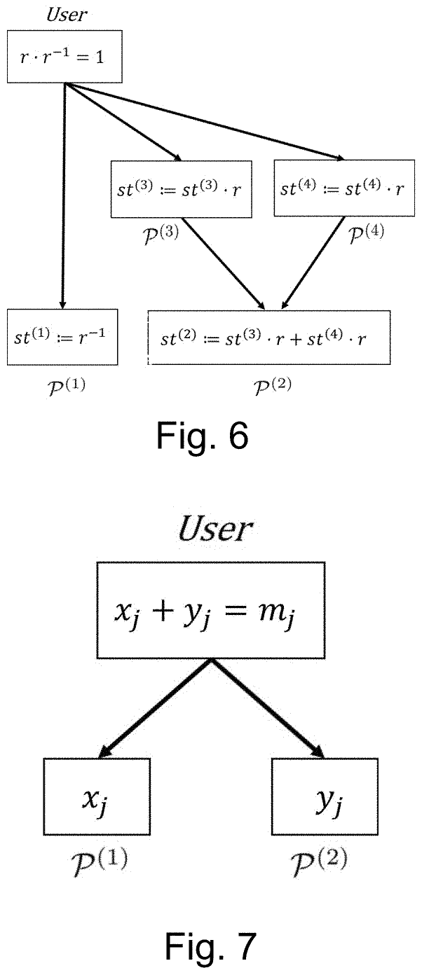

This procedure is invoked by the user and all the participants at stages i such that opᵢ is multiplication and the current mode is addition. As described in FIG. 6, the user mult.-random-splits 1∈ [symbol] ₚ to r·r⁻¹, and sends r⁻¹ to [symbol] ⁽¹⁾ and r to the A.parties. Then, [symbol] ⁽¹⁾ sets st⁽¹⁾ to r⁻¹. Each of the A.parties, [symbol] ^{(j)}, (j=3,4), multiplies r by st^{(j)} and sends the product to [symbol] ⁽²⁾. At this stage the A.parties are eliminated. Then [symbol] ⁽²⁾ adds the values received and sets st⁽²⁾ to the sum.

In this case,

st=st⁽³⁾+st⁽⁴⁾=r⁻¹·(r·(st⁽³⁾+st⁽⁴⁾))=r⁻¹·(r·st⁽³⁾+r·st⁽⁴⁾)=st⁽¹⁾·st⁽²⁾.

Thus, from the two add.-random-split shares of st that were held by the A.parties, the M.parties receive mult.-random-split shares of st. At this stage, [symbol] ⁽¹⁾ obviously has no information about st. Since st≠0 and r is random, [symbol] (²) also has no information about the current state.

At any stage of the scheme:
The computation state is not saved as plaintext anywhere.
Whenever a value mᵢ∈ [symbol] ₚ is received by the user, she immediately random-splits it, eliminates it and distributes its shares.
None of the participants gains any information about the values m, or st.
The user can retrieve the shares of st from the participants and efficiently compute st.

This scheme allows a user to perform information-theoretically secure outsourcing of any non-vanishing stream using four participants.

### Scheme 2: A Bounded Stream

In the scheme proposed for a Non-vanishing stream, the depth and length of the arithmetic circuit are practically unbounded. This fact can be used to outsource arbitrarily long computation streams, containing any number of multiplications and additions in [symbol] ₚ. There is a constraint, though, on the possible result of each stage of the computation. Namely, none of them may be zero. In some cases, one has a computation stream that does not meet this limitation.

According to an embodiment of the invention, it is possible to outsource stream computations that may vanish by assuming that the depth and length of the stream are bounded. The proposed scheme is based on the non-vanishing scheme. Similarly to the assumptions of the non-vanishing scheme, it is assumed that the values m, are elements of a finite field [symbol] _{q} (q is prime), and that the arithmetic operations are multiplication and addition in [symbol] _{q}.

Assuming that M=(m₀, m₁, . . . , mₙ)∈ [symbol] _{q}ⁿ⁺¹ is a sequence of values produced by a source in some stream computation, and that OP=(op₁, . . . , opₙ)∈{‘+’,‘·’}ⁿ is the sequence of operations produced by it corresponding to M, at each stage of the computation, the computation state st is the result of applying the operations in OP to the corresponding values in M, where operations are carried out in [symbol] _{q}. One gets the exact same result by performing the computation over the positive integers and taking the result modulo q. Formally, for each entry mᵢ of M, let aᵢ∈{1, 2, . . . , q}⊆ [symbol] denote the minimal positive integer such that aᵢ≡mᵢ(mod q). The aᵢ's are the integer correspondents of the mᵢ's. Then, by performing the stream computation over the aᵢ's (while using the same operations over the integers), an integer result st [symbol] is obtained, such that s [symbol] ≡st(mod q). Assuming a computation stream over elements in [symbol] _{q} is such that, when performing the corresponding stream computation over the integers, an integer-computation state, s [symbol] , that never exceeds a large prime p is obtained. Such a computation stream is called p-bounded.

The following scheme is proposed to perform information-theoretically secure outsourcing of a p-bounded computation stream. As in the non-vanishing scheme, it is assumed that the user has a secure connection channel with four honest-but-curious participants [symbol] ^{(j)} (1≤j≤4). The general idea behind the scheme is to run at each stage the procedures described above over the integer correspondents of the mᵢ's, modulo p, where operations are carried in [symbol] ₚ.

The scheme stages are:
Upon receiving the initial value m₀∈ [symbol] _{q}, run Init to distribute multiplicative shares of a₀(mod p) to [symbol] ⁽¹⁾ and [symbol] ⁽²⁾, where a₀ is the integer correspondent of m₀.
At stage i, upon receiving mᵢ∈ [symbol] _{q} and an operation opᵢ:
   If opᵢ does not match the current mode, then run M→A or A→M to switch mode eliminating the M.parties or the A.parties.
   Run MinM or AinA to update the computation state shares according to aᵢ(mod p) and opᵢ.

The user can extrapolate st∈ [symbol] _{q} at any stage by retrieving the shares from the participants, computing the computation state modulo p, and then taking the integer correspondent to the result modulo q. The correctness of the scheme is derived from the fact that the stream is p-bounded. The security of this scheme for p-bounded streams is derived from the security of the non-vanishing stream scheme, since from the participants perspective, there is no difference between the cases.

### SMPC of Arithmetic Functions in One Round of Communication

The solutions used to outsource stream computations, give rise to SMPC schemes that allow evaluation of arithmetic functions in one round of communication. The present invention propose schemes that support this task in two different cases: the non-vanishing case and the p-bounded case. In the proposed schemes st, the set of variables over which the function is evaluated may be dynamic, and so may be the function itself.

### One-Round SMPC of Arithmetic Functions Over Non-Zero Elements

The present invention proposes an SMPC scheme that allows a user to securely outsource storage and computations of data under the following assumptions.
The user holds a sequence m=(m₁, . . . , mₙ)∈ [symbol] ₚⁿ.
The user has a private connection channel with four participants [symbol] ^{(k)}, (1≤k≤4). As in the arithmetic streams scenario, this scheme can be generalized to one with a larger number of participants.
The participants are honest-but-curious.

At each stage of the proposed scheme, the participants hold shares of m. This proposed enables a user to secret share m=(m₁, . . . , mₙ) amongst honest-but-curious servers in a way that allows the user to evaluate ƒ(m) using computing engines provided by the servers, where ƒ: [symbol] ₚⁿ→ [symbol] ₚ.

Since [symbol] ₚ is a finite field, any function ƒ: [symbol] ₚⁿ→ [symbol] ₚ can be represented as a multivariate polynomial. The fact that x^{p}≡x(mod p) implies that this representation is not unique (generally, there are infinitely many polynomials of n variables and only a finite number of functions ƒ: [symbol] ₚⁿ→ [symbol] ₚ). Given a function ƒ, it is desired to assign ƒ with a minimal multivariate polynomial representation of it. To this end, a representation of ƒ as a multivariate polynomial such that the degree of each variable is at most p−1 is used. For any given ƒ there is exactly one such multivariate polynomial denoted by Q_{ƒ} and ƒ is assigned with Q_{ƒ} as its minimal multivariate polynomial representation.

The total degree¹ of Q_{ƒ} (The total degree of a multivariate polynomial is the maximal sum of exponents in a single monomial of it) is at most n(p−1) and write

ƒ(m)= [symbol] aᵢ·m₂ⁱ^{₁} . . . mₙⁱ^{ₙ},

where [symbol] ={0, . . . , p−1}ⁿ and aᵢ∈ [symbol] ₚ. There are p^{p}^{ⁿ} such functions. For example, if n=6, p=11, then one of these functions is 3m₁³m₂³m₅+6m₃⁴m₁+2m₃m₆. The fact that each variable in each monomial can appear with any exponent between 0 and p−1 implies that there are pⁿ different monomials. For most functions ƒ used in practice, most of the monomials are irrelevant since they have leading coefficient 0. Nevertheless, in general the number of monomials in the representation of ƒ as a multivariate polynomial is exponential in n. For i=(i₁, . . . , iₙ)∈ [symbol] , the monomial function m₁ⁱ^{₁} . . . mₙⁱ^{ₙ} is denoted by Aᵢ, where Aᵢ is the i'th monomial.

The proposed scheme consists of two protocols:
The Distribution protocol—invoked by the user to secret share m amongst the participants.
The Evaluation protocol—invoked by the user to perform SMPC of a function ƒ over m using the participants.

As in the arithmetic stream schemes presented above, [symbol] ⁽¹⁾ and [symbol] ⁽²⁾ are the M.parties and [symbol] ⁽³⁾ and [symbol] ⁽⁴⁾ are the A.parties. In the distribution protocol, the user secret shares m amongst the M.parties. The Evaluation protocol is composed of four stages:

At the first stage, the user sends information regarding ƒ to the participants, and the M.parties perform operations over their shares of m that correspond to SMPC of each of the (non-zero leading coefficient) monomials Aᵢ of ƒ.

At the second stage, the M.parties send to the A.parties information that allows the A.parties to achieve additive shares of each of the monomials of ƒ. At this point the M.parties are eliminated.

At the third stage, the A.parties use the information they received from the M.parties to achieve shares of ƒ(m).

At the fourth stage, the user can choose between either retrieving the shares of ƒ(m) from the A.parties and computing ƒ(m), or shifting the information from the A.parties to a new set of M.parties (as in A→M) to allow further computations over (m, ƒ(m)) without decrypting ƒ(m).

### The Distribution Protocol

This Distribution protocol is invoked by the user to secret share m=(m₁, . . . , mₙ)∈ [symbol] ₚⁿ amongst the M.parties. For each mⱼ, 1≤j≤n, as described in FIG. 7, the user mult.-random-splits mⱼ to a product of multiplicative shares xⱼ·yⱼ. Then, the user distributes (x₁, . . . , xₙ) to [symbol] ⁽¹⁾ and (y₁, . . . , yₙ) to [symbol] ⁽²⁾.

### The Evaluation Protocol

This protocol is invoked by the user to perform SMPC of a function ƒ over m using the participants. The protocol has four stages.

Stage 1—MonEv—Monomial evaluation

At this stage, the user sends information about ƒ to the participants. The M.parties compute multiplicative shares of the monomials of ƒ. ƒ can be writ in the form ƒ the/monomials

ƒ(m₁, . . . ,mₙ)= [symbol] aᵢ·Aᵢ,

where Aᵢ is the i'th monomial and is determined by i=(i₁, . . . , iₙ). At this stage, for each monomial Aᵢ with non-zero leading coefficient, the user sends i∈ [symbol] to the M.parties and aᵢ∈ [symbol] ₚ to the A.parties. Each of the M.parties evaluates each monomial Aᵢ over his shares. [symbol] ⁽¹⁾ sets Aₓ_{ᵢ}: =Πⱼ₌₁ⁿxⱼⁱ^{ⱼ} and [symbol] ⁽²⁾ sets A_{y}_{ᵢ}:=Πⱼ₌₁ⁿyⱼⁱ^{ⱼ}. Aₓ_{ᵢ} and A_{y}_{ᵢ} are multiplicative shares of Aᵢ evaluated at m:

Aₓ_{ᵢ}·A_{y}_{ᵢ}=Πⱼ₌₁ⁿxⱼⁱ^{ⱼ}·Πⱼ₌₁ⁿyⱼⁱ^{ⱼ}=Πⱼ₌₁ⁿ(xⱼyⱼ)ⁱ^{ⱼ}=Πⱼ₌₁ⁿmⱼⁱ^{ⱼ}=Aᵢ.

Stage 2—SMA—Shift from M.parties to A.parties

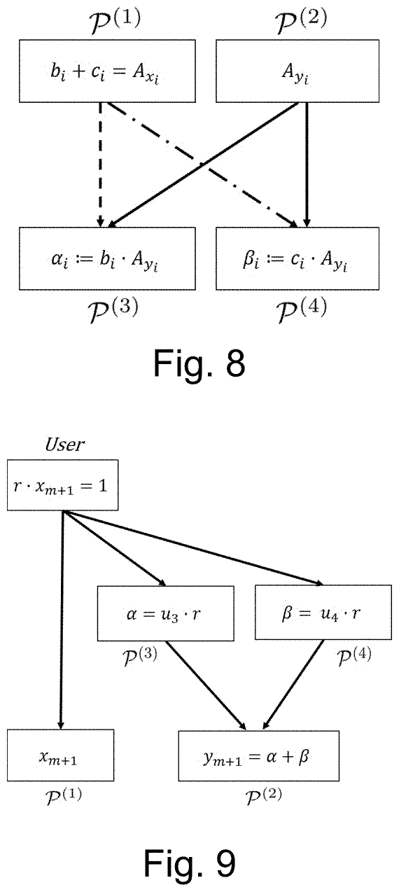

At this stage, for each i received from the user, the M.parties manipulate the multiplicative shares of Aₓ_{ᵢ} and A_{y}_{ᵢ} and send information to the A.parties that enables the A.parties to achieve additive shares of Aᵢ. For each i received, as described in FIG. 8, [symbol] ⁽¹⁾ add.-random-splits Aₓ_{ᵢ} into a sum of two additive shares bᵢ+cᵢ in [symbol] ₚ. Then, [symbol] ⁽¹⁾ sends bᵢ to [symbol] ⁽³⁾ and cᵢ to [symbol] ⁽⁴⁾, while [symbol] ⁽²⁾ sends A_{y}_{ᵢ} to the A.parties. The M.parties are now eliminated and the A.parties multiply the values received. Denote the products calculated by [symbol] ⁽³⁾ and [symbol] ⁽⁴⁾ by αᵢ and βᵢ, respectively.

The multiplicative shares of Aᵢ that were held by the M.parties, the A.parties achieve additive shares of Aᵢ:

Aᵢ=Aₓ_{ᵢ}·A_{y}_{ᵢ}=(bᵢ+cᵢ)·A_{y}_{ᵢ}=bᵢ·A_{y}_{ᵢ}+cᵢ·A_{y}_{ᵢ}=αᵢ+βᵢ.

Since aᵢ and bᵢ are random, the A.parties gain no information about Aᵢ.
Stage 3—fEv—Evaluation of ƒ

At this stage the A.parties compute additive shares of ƒ(m) using the information received from the user at stage 1 and the additive shares of Aᵢ obtained at stage 2.
[symbol] ⁽³⁾ computes u₃: = [symbol] aᵢ·αᵢ.
[symbol] ⁽⁴⁾ computes u₄: = [symbol] aᵢ·βᵢ.
Observe that u₃ and u₄ are additive shares of ƒ(m):

u₃+u₄=Σ [symbol] aᵢ·αᵢ+ [symbol] aᵢ·βᵢ= [symbol] aᵢ·(αᵢ+βᵢ)= [symbol] aᵢ·Aᵢ=ƒ(m).

### Stage 4—RetCas—Retrieving/Cascading

At this stage, the user has a choice between two options: retrieving and cascading. In the retrieving option, the user retrieves the additive shares of ƒ(m) from the A.parties and adds them to obtain ƒ(m). In the cascading option, the user has the A.parties manipulate the shares they hold and send information to a new set of M.parties (in the same fashion as in procedure A→M described above). Then the A.parties are eliminated and the user may begin a new computation over (m₁, . . . , mₙ, ƒ(m)).

### The Cascading Option:

As described in FIG. 9, the user performs mult.-random-split of 1∈ [symbol] Fₚ to two multiplicative shares xₘ₊₁ and r, and sends xₘ₊₁ to [symbol] ⁽¹⁾ and r to the A.parties. Each of the A.parties multiplies r by uₖ, k=3,4, and sends the product to [symbol] ⁽²⁾. At this stage, the A.parties are eliminated. Now [symbol] ⁽²⁾ adds the values received and sets yₘ₊₁ to the sum.

ƒ(m)=u₃+u₄=xₘ₊₁·(r·(u₃+u₄))=xₘ₊₁·yₘ₊₁.

Thus, from the additive shares of ƒ(m) that were held by the A.parties, the M.parties obtain multiplicative shares of ƒ(m), and further functions can be evaluated over (m₁, . . . , mₙ, ƒ(m)) by the user and the participants using stages 1-3 of this protocol. This option is secure only if ƒ(m)≠0, since if ƒ(m) vanishes, then so does yₘ₊₁.

Since each mⱼ is secret shared independently, the set of secrets over which any function can be evaluated is dynamic and further secrets can be shared on the fly. The fact that each monomial is evaluated over the secret shares independently implies that the function itself is dynamic in the sense that new monomials can be evaluated and added on the fly.

One-Round SMPC of p-Bounded Arithmetic Functions

In the scenario considered above, SMPC of arithmetic functions over non-zero elements, there is a limitation on the possible values that the mⱼ's may take. Namely, they cannot be zero. Moreover, if the user wishes to perform further computations over (m, ƒ(m)) without first decrypting ƒ(m), then ƒ(m) must be non-zero, as well.

It is possible to avoid these limitations over the mⱼ's and ƒ(m). In a possible scenario, in which some of the mⱼ's may be zero and ƒ may vanish, the present invention proposes a scheme that overcomes the limitations of the previous scenario assuming ƒ is p-bounded for small enough p. The term p-bounded is defined below.

Similarly to the assumptions of the previous scenario, it is assumed that the values mⱼ are elements of a finite field of prime order q, denoted [symbol] _{q}.

It is assumed that the user holds m=(m₁, . . . , mₙ)∈ [symbol] _{q}ⁿ and wishes to evaluate ƒ(m) for some ƒ. It is possible to compute ƒ(m) by performing operations in [symbol] _{q} on m according to a representation of ƒ as a multivariate polynomial. The same result is obtained if one computes ƒ(m) over the positive integers and then takes the result modulo q. Formally, for each entry mⱼ of m let aⱼ∈{1, 2, . . . , q}⊆ [symbol] denote the minimal positive integer such that aⱼ≡mⱼ(mod q). Then, by performing the computation over the aⱼ's using integer operations, an integer result ƒ [symbol] is obtained, such that ƒ [symbol] ≡ƒ(m)(mod q). A function ƒ: [symbol] _{q}ⁿ→ [symbol] _{q} is p-bounded (considering the minimal multivariate polynomial representation of ƒ, actually, all functions ƒ: [symbol] _{q}ⁿ→ [symbol] _{q} are p-bounded for p≥q^{nq+1}. This fact is not useful for large p) such that for every m∈ [symbol] _{q}ⁿ, computation of ƒ(m) over the integers yields an integer result, ƒ [symbol] , which is strictly smaller than a large prime p.

The proposed scheme is based on that suggested in the previous case for non-zero elements and enables SMPC of p-bounded functions over elements, some of which may be zero. As in the non-zero scheme, it is assumed that the user has a secure connection channel with four honest-but-curious servers, [symbol] ^{(k)}, 1≤k≤4. The general idea behind the scheme is to run at each stage the same procedures as in the scheme suggested in the previous case, over the integer correspondents of the mⱼ's modulo p.

The scheme stages are as follows:

For m=(m₁, . . . , mₙ)∈ [symbol] _{q}ⁿ, let \tilde{m}=(\tilde{m}₁, . . . , \tilde{m}ₙ)∈ [symbol] ₚⁿ denote the element of [symbol] ₚⁿ corresponding to m. That is, \tilde{m}ⱼ:=aⱼ(mod q) for 1≤j≤n. Similarly, for ƒ: [symbol] _{q}ⁿ→ [symbol] _{q}, let \tilde{ƒ}: [symbol] ₚⁿ→ [symbol] ₚ denote the function corresponding to ƒ in the p-world. The Distribution and Evaluation protocols are as follows:

### Distribution

For m∈ [symbol] _{q}ⁿ use the Distribution protocol of the non-zero scheme to secret share \tilde{m}∈ [symbol] ₚⁿ among the M.parties.

### Evaluation

For ƒ: [symbol] _{q}ⁿ→ [symbol] _{q} use the Evaluation protocol of the non-zero scheme to evaluate \tilde{ƒ} over \tilde{m}:
The first three stages are the same as in the non-zero protocol.
At the fourth stage, RetCas:
   Decryption is done by retrieving \tilde{ƒ}(\tilde{m}) by the dealer and taking the integer corresponding to \tilde{ƒ}(\tilde{m}) modulo q.
   Cascading (performing further computations over (m₁, . . . , mₙ, ƒ(m)) without first decrypting ƒ(m)) can be done under the following assumptions. Assume the user wishes to perform SMPC of g: [symbol] _{q}ⁿ⁺¹→ [symbol] _{q} over (m₁, . . . , mₙ, ƒ(m)). Use Q_{ƒ} to write gas a function from [symbol] _{q}^{m} to [symbol] _{q}. If g is p-bounded considering its representation as a multivariate polynomial obtained by using Q_{ƒ} to write g as a function from [symbol] _{q}^{m} to [symbol] _{q}, then SMPC of g over (m₁, . . . , mₙ, ƒ(m)) can be done with no need to first decrypt ƒ(m) by the user.

This protocol has the same dynamic attributes as those suggested in the previous scenario and it requires a single round of communication.

The schemes presented above are perfectly secure against attacks of coalitions, smaller than the number of currently active participants.

### Handling Both Operations by the Same Participants

It is possible to perform SMPC of arithmetic functions over secret shares using the same set of participants for both operations.

### A Scheme for the Non-Vanishing Case:

Similarly to the scenarios mentioned above, SMPC of arithmetic functions over secret shares, some of which may be zero, can be performed assuming the function is p-bounded. It is assumed that a user, holding k non-zero elements S=(s₁, . . . , sₖ)∈ [symbol] ₚ^{k}, has a private connection channel with n honest-but-curious participants, [symbol] ⁽¹⁾, . . . , [symbol] ⁽ⁿ⁾.

### Distribution:

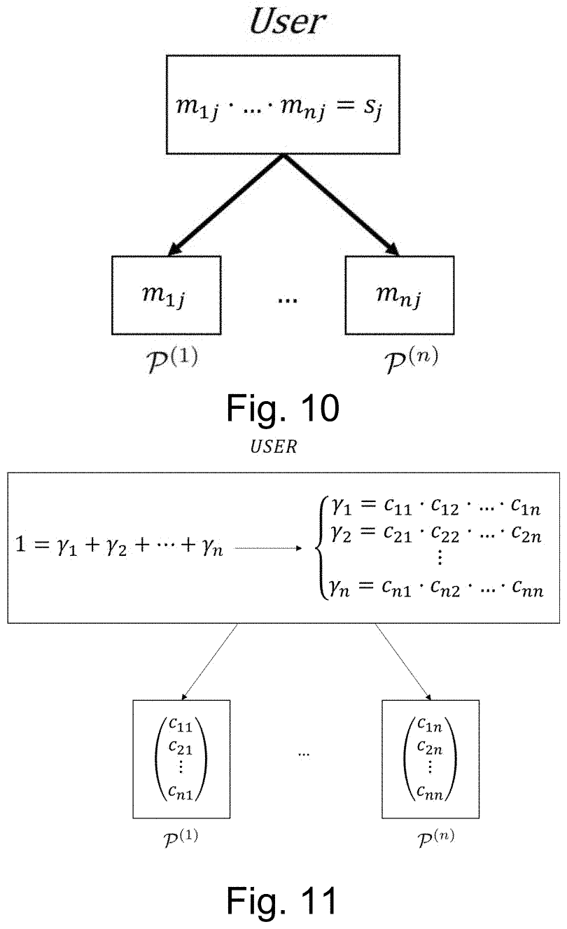

For sⱼ, 1≤j≤k, perform mutt.-random-split of sⱼ to multiplicative shares, mᵢⱼ, such that sⱼ=Πᵢ₌₁ⁿ mᵢⱼ and distribute mᵢⱼ to [symbol] ⁽ⁱ⁾. This is illustrated in FIG. 10.

### Evaluation:

Assuming a user that wishes to perform SMPC of a function ƒ: [symbol] ₚ^{k}→ [symbol] ₚ over S, where the minimal multivariate polynomial representation of ƒ is

ƒ(x₁, . . . ,xₖ)=Σₗ₌₍ₗ_{₀}_{, . . . ,l}_{ₖ}_{)∈} [symbol] l₀·x₁^{l}^{₁} . . . xₖ^{l}^{ₖ}

and [symbol] ={0, . . . , p−1}^{k+1}. In the this procedure, the monomials of ƒ are evaluated by the participants separately and then added to obtain secret shares of ƒ(s₁, . . . , sₖ). For l∈ [symbol] , the l'th monomial is l₀·x₁^{l}^{₁} . . . xₖ^{l}^{ₖ}. To evaluate the l'th monomial:
1. Send l to the participants.
2. Perform matrix-random-split of 1 to C∈Mₙ( [symbol] ₚ):
   (a) Perform add.-random-split of 1∈ [symbol] ₚ to γ₁+ . . . +γₙ.
   (b) For 1≤i≤n:
      i. Choose uniformly at random n−1 non-zero elements of [symbol] ₚ, cᵢⱼ, for 1≤j≤n, j≠i. Denote δ=c_{i,1} . . . c_{i,j-1}·c_{i,j+1} . . . c_{i,n}.
      ii. Set cᵢᵢ=γᵢ/δ.
   (c) Denote C=(cᵢⱼ)_{i,j=1}ⁿ∈Mₙ( [symbol] ₚ).
3. Distribute to each [symbol] ⁽ⁱ⁾ the i'th column [C]ᵢ of C.
4. Each [symbol] ⁽ⁱ⁾ computes:

αᵢ: =(Πⱼ₌₁^{k}mᵢⱼ^{l}^{ⱼ})·[C]ᵢ.

αᵢ is [symbol] ⁽ⁱ⁾'s alpha vector.
5. For 1≤i≤n, each of the participants sends the i'th entry of the alpha vector, computed in the previous stage, to [symbol] ⁽ⁱ⁾.
6. Each of the participants multiplies the values received in the previous stage and computes:

Uᵢ=l₀·(α₁)ᵢ· . . . ·(αₙ)ᵢ.

For each l, the Uᵢ's obtained by the participants at stage 6 of the evaluation protocol are additive shares of the l'th monomial of ƒ evaluated on S. One has

$$\begin{matrix}{U}_{i} = {l}_{0} \cdot {( {α}_{1} )}_{i} \cdot … \cdot {( {α}_{n} )}_{i} = {l}_{0} \cdot ( {c}_{i 1} \cdot {\prod }_{j = 1}^{k} {m}_{1 j}^{{l}_{j}} ) \cdot … \cdot ( {c}_{in} \cdot {\prod }_{j = 1}^{k} {m}_{nj}^{{l}_{j}} ) \\ = {l}_{0} \cdot ( {c}_{i 1} \cdot … \cdot {c}_{in} ) \cdot {\prod }_{j = 1}^{k} {( {\prod }_{i = 1}^{n} {m}_{ij} )}^{{l}_{j}} = {l}_{0} \cdot {γ}_{i} \cdot {\prod }_{j = 1}^{k} {s}_{j}^{lj} .\end{matrix}$$

$$Hence , \\ {\sum }_{i = 1}^{n} {U}_{i} = {\sum }_{i = 1}^{n} ( {l}_{0} \cdot {γ}_{i} \cdot {\prod }_{j = 1}^{k} {s}_{j}^{lj} ) = {l}_{0} \cdot {\prod }_{j = 1}^{k} {s}_{j}^{lj} \cdot {\sum }_{i = 1}^{n} {γ}_{i} .$$

Since Σᵢ₌₁ⁿ γᵢ=1, the sum of the Uᵢ's equals to the l'th monomial of ƒ evaluated on S.

Now, following the procedure described above, each participant [symbol] ⁽ⁱ⁾ obtains such Uᵢ for each of the monomials of ƒ. Denote by Uᵢ^{(l)} the Uᵢ obtained by [symbol] ⁽ⁱ⁾ regarding the l'th monomial of ƒ. Adding the Uᵢ^{(l)}'s, the i'th participant obtains an additive share of ƒ evaluated on S. These shares can be used to perform consecutive computations in the following way:

Assuming that ƒ₁ and ƒ₂ are two functions evaluated on S as suggested above, the additive shares of ƒ₁(S) and ƒ₂(S) held by the participants can be added by the participants to obtain additive shares of ƒ₁(S)+ƒ₂(S). The same holds for a linear combination of an arbitrary number of functions ƒ₁, . . . , ƒ_{d} evaluated on S.

SMPC of the product ƒ(S)·l₀·s₁^{l}^{₁} . . . sₖ^{l}^{ₖ} for given l can be performed by generating a matrix-random-split of ƒ(S) using the additive shares of ƒ(S) held by the participants. Denote by γ₁, . . . , γₙ the additive shares of ƒ(S) held by the participants at the end of the evaluation procedure. Similarly to stage 2 of it, each participant [symbol] ⁽ⁱ⁾ performs mult.-random-split of γᵢ to cᵢ₁· . . . ·cᵢₙ. The cᵢⱼ's constitute a matrix-random-split of ƒ(S). Each participant distributes the multiplicative shares of its additive share of ƒ(S) to the other participants in a way that each participant [symbol] ⁽ⁱ⁾ receives the i'th column of C. Now, SMPC of the product ƒ(S)·l₀·s₁^{l}^{₁} . . . sₖ^{l}^{ₖ} can be performed following stages 4-6 of Evaluation. In the end of which, additive shares of the product ƒ(S)·l₀·s₁^{l}^{₁} . . . sₖ^{l}^{ₖ} are held by the participants.

The procedures described above allow SMPC of arithmetic functions over secret shares in one round of communication using one set of participants. A variation of these procedures allows SMPC of arithmetic streams using one set of participants. The procedures MinM and AinA, described in Section 2, are implemented in the same way in this case. Switching from multiplicative shares of sⱼ to additive shares of sⱼ is implemented using Evaluation to perform SMPC of the function ƒ(x₁, . . . , xₖ)=sⱼ. Switching from additive shares of sⱼ to multiplicative shares of sⱼ is implemented as described above for computing a product ƒ(S)·l₀·s₁^{l}^{₁} . . . sₖ^{l}^{ₖ}. This covers the non-vanishing case.

The case where S may contain zeros is handled in the same way as in Section 3, assuming the function is q-bounded for some large prime q.

The scheme presented above is perfectly secure against coalitions of up to all but one of the participants.

### Extensions:

An Example of More than Four Participants

The schemes described above employ four participants. However, the ideas behind the procedures, from which the schemes are composed, generalize to a larger number of participants. Assuming that one wishes to run the schemes using n₁ M.parties and n₂ A.parties (n₁, n₂≥2), the present invention proposes ways to generalize the procedures described above to suit n₁+n₂ participants.

### Random-Split

The procedure mult.-random-split described above can be generalized to n₁ M.parties by taking n₁−1 random non-zero elements of the field, x₁, . . . , xₙ_{₁}₋₁, and computing the xₙ_{₁} that yields Πᵢ₌₁ⁿ^{₁} xᵢ=m. The generalization of add.-random-split. to n₂ participants is analogous.

Additive Shares from Multiplicative Shares

Procedure M→A of the arithmetic streams scenario and procedure SMA of the Evaluation protocol in the arithmetic functions scenario demonstrate shifting of information from two M.parties, [symbol] ⁽¹⁾ and [symbol] ⁽²⁾, to two A.parties, [symbol] ⁽³⁾ and [symbol] ⁽⁴⁾. These procedures are used to produce additive shares of the secret shared data from multiplicative shares of it. These procedures may be generalized to be procedures by which information is shifted from n₁ M.parties to n₂ A.parties in the following way. Assuming that n₁ M.parties, [symbol] ⁽ⁱ⁾, 1≤i≤n₁, hold n₁ multiplicative shares, xᵢ, of an element m, to achieve n₂ additive shares of m held by n₂ A.parties, [symbol] ⁽¹⁾ add.-random-splits x₁ to n₂ additive shares bⱼ, 1≤j≤n₂, and sends each bⱼ to the j'th A.party. The rest of the M.parties, [symbol] ⁽ⁱ⁾, 2≤i≤n₁, send xᵢ to each of the A.parties. At this stage, the M.parties are eliminated and the A.parties multiply the values received to obtain additive shares of m.

Observe that:

m=Πᵢ₌₁ⁿ^{₁}xᵢ=x₁·Πᵢ₌₂ⁿ^{₁}xᵢ=(Σⱼ₌₁ⁿ^{₂}bⱼ)·Πᵢ₌₂ⁿ^{₂}(bⱼ·Πᵢ₌₂ⁿ^{₁}xᵢ).

Multiplicative Shares from Additive Shares

Procedure A→M of the arithmetic streams scenario and procedure RetCas of the Evaluation protocol (the cascading options of RetCas) in the arithmetic functions scenario demonstrate shifting of information from two A.parties to two M.parties. These procedures are used to produce multiplicative shares of the secret shared data from additive shares of its. These procedures generalize to procedures by which information is shifted from n₂ A.parties to n₁ M.parties in the following way. Assume n₂ A.parties, [symbol] ⁽ⁱ⁾, 1≤i≤n₂, hold n₂ additive shares, xᵢ, of an element m. To obtain n₁ multiplicative shares of m held by n₁ M.parties, the user mult.-random-splits 1 to n₁ multiplicative shares. The user sends n₁−1 M.parties one (distinct) multiplicative share of 1, and sends the last share of 1 to all of the A.parties. Each of the A.parties then multiplies the multiplicative share of 1 received by its additive share of m and sends the product to the last M.party. At this stage, the A.parties are eliminated and the last M.party adds the values received. Now the M.parties hold multiplicative shares of m.

Evaluation of boolean circuits. The schemes suggested in Sections 2 and 3 may be used to perform computations of boolean streams and SMPC of boolean circuits by working in [symbol] ₂. A True boolean value is 1∈ [symbol] ₂ and a False boolean value is 0∈ [symbol] ₂. Boolean operations may be identified with field operations in the following way. The A operation is identified with [symbol] ₂ multiplication, the ⊕ operation with [symbol] ₂ addition, and the ┐ operation with adding 1 in [symbol] ₂. The V operation of two literals is identified with x+y+x·y, where x and y are the elements of [symbol] ₂ corresponding to the literals. Then, given a boolean circuit C over boolean literals b₁, . . . , bₙ∈{True, False}, one can use the schemes, suggested above for p-bounded functions, to perform boolean streams computation and SMPC of boolean circuits by taking m₁, . . . ,mₙ∈ [symbol] ₂, where the mᵢ's are the [symbol] ₂ correspondents of the bᵢ's. The boolean circuit C: {True, False}ⁿ→{True, False} will be taken as a function \tilde{C}: [symbol] ₂ⁿ→ [symbol] ₂.

Evaluating functions over inputs held by more than one participant. The schemes suggested in Sections 3 and 4 can be used to perform SMPC of arithmetic functions over inputs held by several participants. Instead of having only one participant holding inputs, assume [symbol] ⁽¹⁾, . . . , [symbol] ^{(k)} are k users, each of whom is holding a set of secret values in [symbol] ₚ. The users wish to privately evaluate a function ƒ over the entire set of variables. Following the distribution protocol, each of the users distributes shares of her secrets. Let one of the users invoke the evaluation protocol, sending the relevant information to the other participants. At the final stage of the evaluation protocol, the participants send their outputs to all of the users. Adding these outputs, each of the users obtains the result of evaluating ƒ over the entire set of secrets. This way, the proposed scheme is extended to support SMPC of functions over inputs held by several participants.

### Three Millionaires Example:

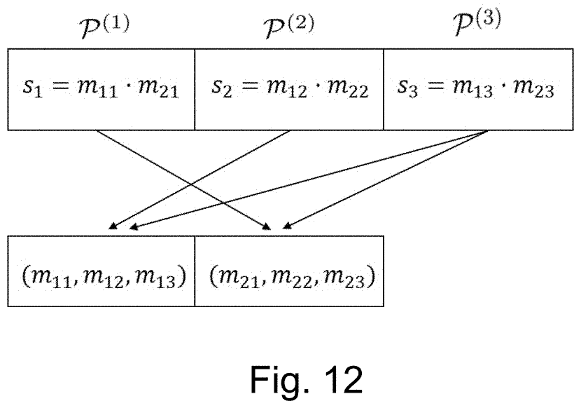

His example describes how the scheme suggested in Section 4 may be used to perform secure multiparty computation. Consider the following scenario. Three millionaires wish to find out who of them is the wealthiest, while not revealing to each other the exact number of millions they possess. Denote the three millionaires by [symbol] ⁽¹⁾, [symbol] ⁽²⁾, [symbol] ⁽³⁾ and the number of millions they possess by s₁, s₂, s₃, respectively. For simplicity, assume sᵢ (1≤i≤3) are positive integers between 1 and 10 (other cases may be solved similarly). The first step is distribution, where p=11. For 1≤i≤3, [symbol] ⁽ⁱ⁾ mult.-random-splits sᵢ to a product of multiplicative shares m_{1,i}·m_{2,i} and distributes m_{1,i} to [symbol] ⁽¹⁾ and m_{2,i} to [symbol] ⁽²⁾.² This is illustrated in FIG. 12.

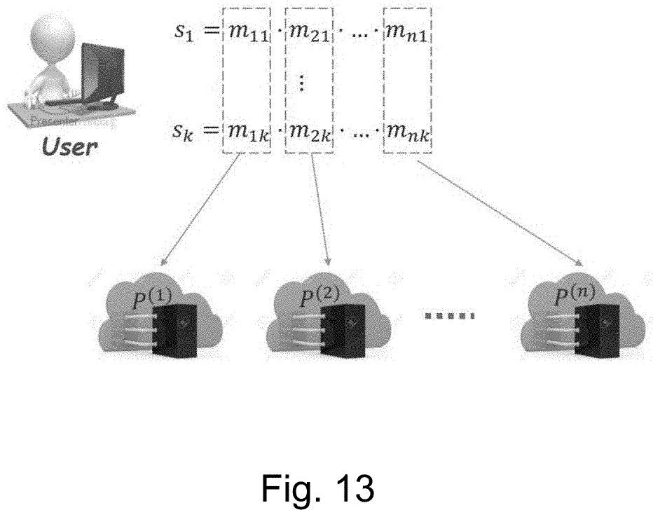

FIG. 13 illustrates a system for performing distribution for sⱼ, 1≤j≤k, performing mult.-random-split of sⱼ to multiplicative shares, mᵢⱼ, among n participants [symbol] ⁽¹⁾, . . . , [symbol] ⁽ⁿ⁾, such that sⱼ=Πᵢ₌₁ⁿ mᵢⱼ. Each of the participants may be an untrusted computing cloud or another untrusted computerized system.

In order to find out which of them is the wealthiest, the participants may evaluate ƒ(x₁, x₂, x₃) at (s₁, s₂, s₃), where ƒ: [symbol] ₁₁³→ [symbol] ₁₁ (one may correctly state that, the procedure mult.-random-split is defined for elements of [symbol] ₚ, while the sᵢ's are integers. Hence, for 1≤i≤3, one should consider s̅ᵢ∈ [symbol] ₚ such that s̅ᵢ≡sᵢ(mod 11) and work with the s̅ᵢ's. sᵢ is written instead of s̅ᵢ occasionally) is the function that returns (a) 0, if x₁=x₂=x₃; (b) i, if xᵢ is larger (as an integer) than the two other variables; (c) i+j+1, if xᵢ=xⱼ (where i≠j) and xᵢ, xⱼ are both larger (as integers) than the other variable. The (minimal) representation of ƒ as a multivariate polynomial is given in the appendix. Let:

ƒ(x₁,x₂,x₃)=Σ_{i,j,k=0}¹⁰a_{i,j,k}·x₁ⁱx₂^{j}x₃^{k}.

[symbol]

⁽³⁾ takes the role of the user, performing, for each monomial a_{i,j,k}·x₁ⁱx₂^{j}x₃^{k} of ƒ, an independent matrix-random-split of 1∈ [symbol] ₁₁ to

$${C}_{i , j , k} = ( \begin{matrix}{c}_{11}^{( i , j , k )} & {c}_{12}^{( i , j , k )} \\ {c}_{21}^{( i , j , k )} & {c}_{22}^{( i , j , k )}\end{matrix} ) ,$$

and sending the left column of C_{i,j,k} to [symbol] ⁽¹⁾ and the right column to [symbol] ⁽²⁾. Subsequently, for each column vector they receive, [symbol] ⁽¹⁾ and [symbol] ⁽²⁾ compute

$${α}_{1}^{( i , j , k )} \text{:=} {m}_{11}^{i} {m}_{12}^{j} {m}_{13}^{k} \cdot ( \begin{matrix}{c}_{11}^{( i , j , k )} \\ {c}_{21}^{( i , j , k )}\end{matrix} ) and {α}_{2}^{( i , j , k )} \text{:=} {m}_{21}^{i} {m}_{22}^{j} {m}_{23}^{k} \cdot ( \begin{matrix}{c}_{12}^{( i , j , k )} \\ {c}_{22}^{( i , j , k )}\end{matrix} ) ,$$

respectively. For each alpha vector, [symbol] ⁽¹⁾ sends the second entry of α₁^{(i,j,k)}, denoted by (α₁^{(i,j,k)})₂, to [symbol] ⁽²⁾, while [symbol] ⁽²⁾ sends the first entry of α₂^{(i,j,k)}, denoted by (α₂^{(i,j,k)})₁, to [symbol] ⁽¹⁾. Using the values received, [symbol] ⁽¹⁾ computes

A=Σ_{i,j,k}a_{i,j,k}·(α₁^{(i,j,k)})₁·(α₂^{(i,j,k)})₁,

while [symbol] ⁽²⁾ computes

B=Σ_{i,j,k}a_{i,j,k}·(α₁^{(i,j,k)})₂·(α₂^{(i,j,k)})₂.

Eventually, [symbol] ⁽¹⁾ and [symbol] ⁽²⁾ publish A and B. Observe that

$$\begin{matrix}A = {Σ}_{i , j , k} {a}_{i , j , k} \cdot ( {m}_{11}^{i} {m}_{12}^{j} {m}_{13}^{k} \cdot {c}_{11}^{( i , j , k )} ) \cdot ( {m}_{21}^{i} {m}_{22}^{j} {m}_{23}^{k} \cdot {c}_{12}^{( i , j , k )} ) \\ = {Σ}_{i , j , k} {a}_{i , j , k} \cdot {s}_{1}^{i} {s}_{2}^{j} {s}_{3}^{k} \cdot {c}_{11}^{( i , j , k )} \cdot {c}_{12}^{( i , j , k )} .\end{matrix}$$

### Similarly,

B=Σ_{i,j,k}a_{i,j,k}·s₁ⁱs₂^{j}s₃^{k}·c₂₁^{(i,j,k)}·c₂₂^{(i,j,k)}.

Adding, one obtains

A+B=Σ_{i,j,k}a_{i,j,k}·s₁ⁱs₂^{j}s₃^{k}·(c₁₁^{(i,j,k)}·c₁₂^{(i,j,k)}·c₂₁^{(i,j,k)}·c₂₂^{(i,j,k)}).

The fact that each C_{i,j,k} is a matrix-random-split of 1 implies that

A+B=Σ_{i,j,k}a_{i,j,k}·s₁ⁱs₂^{j}s₃^{k}·=ƒ(s₁,s₂,s₃).

### Keeping the Circuits Secure

In the schemes suggested in Sections 2 and 3, some information about the circuit itself is revealed to the participants. In the arithmetic streams schemes, the M.parties (respectively, A.parties) know exactly how many consecutive multiplications (respectively, additions) are computed in a specific part of the circuit. In the SMPC schemes, some information about ƒ itself is revealed to the participants, as according to the Evaluation protocol, the user sends the relevant elements i∈ [symbol] to the M.parties and the corresponding aᵢ's to the A.parties. That leakage of information may be prevented by adding noise to the procedure in cost of communication complexity.

### Securing Arithmetic Streams

The arithmetic streams schemes are adjusted to prevent leakage of information about the computation circuit itself. At each stage of the computation, perform both addition and multiplication operations that yield the same result that would have been obtained normally. If at stage i one has opᵢ=‘·’ (meaning that the user needs to multiply st by mᵢ), then
use MinM to multiply st by mᵢ,
use M→A to switch from multiplication mode to addition mode and eliminate the M.parties,
use AinA to add 0 to st,
use A→M to switch back from addition mode to multiplication mode, using a new set of M.parties, and eliminate the A.parties.

If at stage i the user needs to add mᵢ to st, then
use MinM to multiply st by 1,
use M→A to switch from multiplication mode to addition mode and eliminate the M.parties,
use AinA to add mᵢ to st,
use A→M to switch back from addition mode to multiplication mode, using a new set of M.parties, and eliminate the A.parties.

This adjustment costs in communication complexity, but it keeps the arithmetic circuit secure in a way that none of the participants can tell what are the arithmetic operations that are actually being performed.

### Securing Arithmetic Functions

The information held by the user is m=(m₁, . . . , mₙ)∈ [symbol] ₚⁿ. It is possible to take redundant copies of each (or some) of the mᵢ's, take redundant variables that equal 1∈ [symbol] ₚ, take redundant variables that equal 0∈ [symbol] ₚ, and permute them all to obtain m′=(m′₁, . . . , m′ᵣ) which contains the information began with, along the added redundancy. This expansion of m costs in communication complexity but now it is possible to hide ƒ in several ways.

Recall that

ƒ(m)= [symbol] aᵢ·Aᵢ, aᵢ∈ [symbol] ₚ,

where Aᵢ is the i'th monomial. In most applications, most of the aᵢ's are zero, and their corresponding monomials are called the zero monomials. The other monomials are called the non-zero monomials. Now, one can mask ƒ by the following procedures. To evaluate ƒ: [symbol] ₚⁿ→ [symbol] ₚ over m, take some suitable ƒ′: [symbol] ₚ^{r}→ [symbol] ₚ and evaluate it over m′ in such a way that ƒ(m)=ƒ′(m′).

An appropriate choice of ƒ′ may mask ƒ in the following ways:
The non-zero monomials of ƒ can be represented in various forms. Since m′ contains redundant copies of the variables of m and redundant 1-variables, one can compute monomials of ƒ by various choices of monomials of ƒ′. For example, if one of the monomials of ƒ is x₁⁸, and m′ contains redundant copies of m₁, m′₂=m′₃=m′₄=m₁ and m′₅=1, then the corresponding monomial of ƒ′ may be x₂²x₃³x₄³x₅³.
Since m′ contains redundant 0-variables, one can take an ƒ′ which contains redundant monomials with a redundant 0-variable. For example, if ƒ(m)=m₁², then one can take ƒ′(m′)=m′₁²+4m′₆³m′₈, where m′₁=m₁ and m′₆ or m′₈ equal zero. The user should keep in mind the indices of the redundant variables.

These procedures add noise to the computation circuit but cost in an expansion of m and communication complexity.

### Malicious Participants and Threshold Analysis

The correction and security of our schemes are based on the assumption that the participants are honest-but-curious, and that they do not form coalitions. Therefore, it is assumed that each of the participants follows the exact directions of each procedure of the scheme and is not sending to any of the other participants information not supposed to be sent. Nevertheless, it is assumed that the participants are trying to learn information about the secret shared inputs and about the computation circuits through the data received during the execution of the scheme. In case of deviation of a participant from the directions of the scheme, either the scheme might yield an incorrect solution or the security of the secret shared data may be compromised.

The following description discusses ways to detect incorrect outputs caused by malicious participants and analyze the threshold for ensuring the security of the schemes against coalitions of participants.

### Output Verification

Detection of incorrect output caused by malicious participants is achieved either by repeating the same computations while using different sets of participants, or by computing different representations of the same function. Assume one runs our scheme using a total of n participants. Fora positive integer, s, one can uses sets of n participants, where in each set the participants run the same protocol independently. As s is taken to be larger, the correction of the output can be verified with higher certainty. Another approach to detect an incorrect output is to compute the same circuit several times using the same n participants with different randomization in each computation and different representations of the same circuit in each iteration. In this case, one may use schemes for masking the computation as described above, thus ensuring that the participants cannot force repeated incorrect output in successive computations of the same circuit. A repeated incorrect zero output can be forced by a malicious M.party by outputting zero regardless of the inputs received. These two approaches can be combined to reveal malicious participants in the following way. The user can use more than n participants and repeat the same computations (independently) using different n participants on each iteration. Assuming the user receives different outcomes, she can eliminate both sets of participants and repeat the process until identical results are obtained.

### Security

The security of the proposed schemes against attacks of coalitions of participants that join their shares of m in an attempt to learn information about the secret shared inputs will be described. Assume a user runs a scheme, as suggested above, using n₁ M.parties and n₂ A.parties. For each product of n₁−1 non-zero elements of a finite field, xᵢ, 1≤i≤n₁−1, and for each non-zero element m of the field, there exists exactly one element xₙ_{₁} in the field such that the product of all the n₁ elements xᵢ yields m. This fact implies that in case of an attack of a coalition of M.parties, if the size of the coalition is up to n₁−1, then no information about the secret shared input can be gained by the coalition. Similarly, For each sum of n₂−1 elements of a finite field, xᵢ, 1≤i≤n₂−1, and for each element m of the field, there exists exactly one element xₙ_{₂} in the field such that the sum of all the n₂ elements xᵢ yields m. Hence, in case of an attack of a coalition of A.parties, if the size of the coalition is up to n₂−1, no information about the secret shared input can be gained by the coalition. Therefore, the threshold of the schemes is the number of currently-active participants.

In Section 4 the description showed how to perform SMPC of arithmetic functions over secret shares using the same set of n participants for both operations. That scheme is information-theoretically secure against coalitions of up to n−1 honest-but-curious participants. The security of the distribution protocol is derived from the same arguments as in the two sets scenario.

The security of the evaluation protocol of the single set scenario:

Assuming that [symbol] ⁽¹⁾, . . . , [symbol] ⁽ⁿ⁻¹⁾ is a coalition of n−1 participants joining the information they received in an attempt to extract information regarding the values of the sᵢ's. The coalition is referred to as the adversary and summarize the information held by it by the following equations.

During the distribution protocol, the adversary receives the following information regarding the secrets:

s₁=m_{n,1}·Πᵢ₌₁ⁿ⁻¹mᵢ₁

sₖ=m_{n,k}·Πᵢ₌₁ⁿ⁻¹mᵢₖ (1)

The unknowns in (1) are m_{n,j}, sⱼ for 1≤j≤k. The products Πᵢ₌₁ⁿ⁻¹ mᵢⱼ for 1≤j≤k are known.

By same arguments as in the two sets scenario, the adversary gains no information regarding the sᵢ's from (1).

During stage 3 of the evaluation protocol, the adversary receives the following information regarding C=(cᵢⱼ)_{i,j=1}ⁿ, the matrix-random-split of 1∈ [symbol] ₚ:

c_{1,n}·Πᵢ₌₁ⁿ⁻¹c₁ᵢ+ . . . +c_{n,n}·Πᵢ₌₁ⁿ⁻¹cₙᵢ=1 (2)

The unknowns in (2) are c_{i,n} for 1≤i≤n. The products Πᵢ₌₁ⁿ⁻¹cⱼᵢ for 1≤j≤n are known. The matrix C is generated at stage 2 of Evaluation for the computation of the l'th monomial. C is independent of S (and of the l'th monomial), and hence the adversary cannot gain any information regarding S from (2).

Assuming that the l'th monomial of ∂ is l₀·A(x₁, . . . ,xₖ), where A(x₁, . . . ,xₖ)=x₁^{l}^{₁}· . . . ·xₖ^{l}^{ₖ}. During stage 5 of Evaluation, the participants send to each other information. The information received by the adversary from [symbol] ⁽ⁿ⁾ may be summarized by the following equations:

$${( {α}_{n} )}_{1} = {c}_{1 , n} \cdot A ( {m}_{n , 1} , … , {m}_{n , k} ) , \\ {⋮ \\ ( {α}_{n} )}_{n - 1} = {c}_{n - 1 , n} \cdot A ( {m}_{n , 1} , … , {m}_{n , k} ) . \qquad ( 3 )$$

The values (αₙ)ⱼ for 1≤j≤n−1, appearing in (3), are known to the adversary, since these are the first n−1 entries of the alpha vector, αₙ, computed by [symbol] ⁽ⁿ⁾ at stage 4 of the distribution protocol, and sent to the adversary at stage 5 of the protocol. The rest of the quantities in (3) are unknown. Since the sᵢ's are non-zero, by (3), for every possible (m_{n,1}, . . . , m_{n,k})∈ [symbol] ₚ^{k} with non-zero entries there exists a (c_{1,n}, . . . , c_{n-1,n})∈ [symbol] ₚⁿ with non-zero entries such that m_{n,1}, . . . , m_{n,k}, c_{1,n}, . . . , c_{n-1,n} form a solution of (3). For each such a solution, substituting in (2), one obtains

Σⱼ₌₁ⁿ⁻¹(Πᵢ₌₁ⁿcⱼᵢ)+c_{n,m}·Πᵢ₌₁ⁿ⁻¹c_{n,i}=1.

Since all other variables are known, solving for cₙ, and obtaining

$${c}_{n . n} = \frac{1 - {\sum }_{j = 1}^{n - 1} ( {\prod }_{i = 1}^{n} {c}_{ji} )}{{\prod }_{i = 1}^{n - 1} {c}_{n , i}} .$$

For every possible choice of non-zero (m_{n,1}, . . . ,m_{n,k}), the system of equations (2)+(3) has a unique solution, implying that no further information regarding the sᵢ's or A(s₁, . . . , sₖ) can be gained by the adversary. Hence, the fact that each monomial is evaluated independently (as shown in FIG. 11) implies that the scheme is information-theoretically secure with a threshold of n−1. The security of the scheme in the p-bounded case follows from that of the scheme in the non-vanishing case, using the same argumes in the two set scenarios.

Although embodiments of the invention have been described by way of illustration, it will be understood that the invention may be carried out with many variations, modifications, and adaptations, without exceeding the scope of the claims.

### REFERENCES

[BIB89] Judit Bar-Ilan and Donald Beaver. Non-cryptographic fault-tolerant computing in constant number of rounds of interaction. In Proceedings of the eighth annual ACM Symposium on Principles of distributed computing, pages 201-209. ACM, 1989.
[BMR90] Donald Beaver, Silvio Micali, and Phillip Rogaway. The round complexity of secure protocols. In Proceedings of the twenty-second annual ACM Symposium on Theory of Computing, pages 503-513. ACM, 1990.
[BOGW88] Michael Ben-Or, Shafi Goldwasser, and Avi Wigderson. Completeness theorems for non-cryptographic fault-tolerant distributed computation. In Proceedings of the twentieth annual ACM symposium on Theory of computing, pages 1-10. ACM, 1988.
[BP16] Zvika Brakerski and Renen Perlman. Lattice-based fully dynamic multi-key fhe with short ciphertexts. In Annual Cryptology Conference, pages 190-213. Springer, 2016.
[CCD88] David Chaum, Claude Crépeau, and Ivan Damgard. Multiparty unconditionally secure protocols. In Proceedings of the twentieth annual ACM symposium on Theory of computing, pages 11-19. ACM, 1988.
[DFK+06] Ivan Damgård, Matthias Fitzi, Eike Kiltz, Jesper Buus Nielsen, and Tomas Toft. Unconditionally secure constant-rounds multi-party computation for equality, comparison, bits and exponentiation. In Theory of Cryptography Conference, pages 285-304. Springer, 2006.
[DGL15] Shlomi Dolev, Niv Gilboa, and Ximing Li. Accumulating automata and cascaded equations automata for communicationless information theoretically secure multi-party computation. In Proceedings of the 3rd Inter-national Workshop on Security in Cloud Computing, pages 21-29. ACM, 2015.
[DIK10] Ivan Damgård, Yuval Ishai, and Mikkel Køigaard. Perfectly secure multiparty computation and the computational overhead of cryptography. In Annual International Conference on the Theory and Applications of Cryptographic Techniques, pages 445-465. Springer, 2010.
[DL16] Shlomi Dolev and Yin Li. Secret shared random access machine. In Algorithmic Aspects of Cloud Computing, pages 19-34. Springer, 2016. [DLY07] Shlomi Dolev, Limor Lahiani, and Moti Yung. Secret swarm unit reactive k-secret sharing. In International Conference on Cryptology in India, pages 123-137. Springer, 2007.
[Gen09] Craig Gentry. A fully homomorphic encryption scheme. Stanford University, 2009.
[GHS12] Craig Gentry, Shai Halevi, and Nigel P Smart. Fully homomorphic encryption with polylog overhead. In Annual International Conference on the Theory and Applications of Cryptographic Techniques, pages 465-482. Springer, 2012.
[GHS16] Craig B Gentry, Shai Halevi, and Nigel P Smart. Homomorphic evaluation including key switching, modulus switching, and dynamic noise management, Mar. 8 2016. U.S. Pat. No. 9,281,941.
[GIKR02] Rosario Gennaro, Yuval Ishai, Eyal Kushilevitz, and Tal Rabin. On 2-round secure multiparty computation. In Annual International Cryptology Conference, pages 178-193. Springer, 2002.
[IK02] Yuval Ishai and Eyal Kushilevitz. Perfect constant-round secure computation via perfect randomizing polynomials. In International Colloquium on Automata, Languages, and Programming, pages 244-256. Springer, 2002.
[KN06] Eyal Kushilevitz and Noam Nissan. Communication Complexity. Cambridge University Press, United Kingdom, 2006.
[Sha79] Adi Shamir. How to share a secret. Communications of the ACM, 22(11):612-613, 1979.
[SV10] Nigel P Smart and Frederik Vercauteren. Fully homomorphic encryption with relatively small key and ciphertext sizes. In International Workshop on Public Key Cryptography, pages 420-443. Springer, 2010.
[VDGHV10] Marten Van Dijk, Craig Gentry, Shai Halevi, and Vinod Vaikuntanathan. Fully homomorphic encryption over the integers. In Annual International Conference on the Theory and Applications of Cryptographic Techniques, pages 24-43. Springer, 2010.
[XWZ+18] Jian Xu, Laiwen Wei, Yu Zhang, Andi Wang, Fucai Zhou, and Chong-zhi Gao. Dynamic fully homomorphic encryption-based merkle tree for lightweight streaming authenticated data structures. Journal of Network and Computer Applications, 107:113-124, 2018.

### APPENDIX

The minimal multivariate polynomial representation of ƒ: ƒ(x, y, z)=x¹⁰+7x²y+6x⁴y+7x⁶y+9x⁸y+3x⁹y+10x¹⁰y+4xy²+10x³y²+x⁵y²+8xy²+3x⁸y²+5x⁹y²+x²y³+2x⁴y+7x³y³+3x⁷y³+7x⁸y³+5xy⁴+9x³y⁴+6x⁵y⁴+3x⁶y⁴+8xy⁴+10xy⁵+5x⁴y⁵+3x⁵y⁵+2x⁶y⁵+4xy⁶+4x³y⁶+3x⁴y⁶+9x⁵y⁶+3x²y⁷+3x³y⁷+3x⁴y⁷+2xy⁸+3x²y⁸+4x³y⁸+3xy⁹+6x²y⁹+2y¹⁰+xy¹⁰+7x¹⁰y¹⁰+3x²z+x⁴z+3x⁶z+7x⁸z+8x⁹z+9x¹⁰z+8xyz+9x³yz+3x⁴yz+2x⁵yz+10xyz+5xyz+5x⁸yz+10x⁹yz+8x¹⁰yz+7y²z+3x²y²+7x³y²+8x⁴y²+2x⁵y²z+5x⁷y²+10x⁸y²z+10x⁹y²z+4x⁰y²z+6x²y³z+x²y³z+3x³y³z+4x⁴y³z+6x⁵y³z+3x⁶y³z+7x⁷y³z+x⁹y³z+7x¹⁰y³z+6y⁴z+4x²y⁴z+7x³y⁴z+x⁴y⁴z+2x⁵y⁴z+9x⁶y⁴z+x⁸y⁴z+9x⁹y²z+5x¹⁰y⁴z+6xy⁵z+10x²y⁵z+7x³y⁵z+x⁴y⁵z+5x⁵y⁵z+2x⁶y⁵z+x⁷y⁵z+7x⁸y⁵z+4x⁹y⁵z+6x¹⁰y⁵z+7y⁶z+2x²y⁶z+7x³y⁶z+3x⁴y⁶z+8x⁵y⁶z+x⁶y⁶z+6x⁶y⁶z+4x⁸y⁶z+3x⁹y⁶z+4x¹⁰y⁶z+8xy⁷z+3x²y⁷z+9x³y⁷z+6x⁴y⁷z+x⁵y⁷z+5x⁶y⁷z+4x⁷y⁷z+5x⁸y⁷z+x⁹y⁷z+7x¹⁰y⁷z+9y⁸z+10xy⁸z+5x²y⁸z+7x³y⁸z+x⁴y⁸z+4x⁵y⁸z+4x⁶y⁸z+6x⁷y⁸z+x⁸y⁸z+9x⁹y⁸z+2x¹⁰y⁸z+2y⁹z+xy⁹z+3x²y⁹z+x³y⁹z+2x⁴y⁹z+4x⁵y⁹z+8x⁶y⁹z+x⁷y⁹z+2x⁸y⁹z+6x⁹y⁹z+10x¹⁰y⁹z+10y¹⁰z+8x²y¹⁰z+4x³y¹⁰z+10x⁴y¹⁰z+5x⁵y¹⁰z+8x⁶y¹⁰z+4x⁷y¹⁰z+4x⁸y¹⁰z+8x⁹y¹⁰z+8xz²+9x³z²+2x⁵z²+5x⁷z²+8x⁸z²+10x⁹z²+4yz²+x²yz²+6x³yz²+3x⁵yz²+6x⁶yz²+x⁷yz²+7x⁸yz²+7x⁹yz²+7x¹⁰yz²+10xy²z²+7x³y²z²+x⁵y²z²+7x⁶y²z²+5x⁷y²z²+7x⁸y²z²+x¹⁰y²z²+10y³z²+10xy³z²+x²y³z²+7x⁴y³z²+5x⁵y³²+10x⁶y³z²+3x⁷y³z²+10x⁸y³z²+2x⁹y³z²+x¹⁰y³z²+10xy⁴z²+2x³y⁴z²+6x⁴y⁴z²+5x⁵y⁴z²+10x⁶y⁴z²+10x⁷y⁴z²+x⁸y⁴z²+7x⁹y⁴z²+9x¹⁰y⁴z²+y⁵z²+xy⁵z²+8x²y⁵z²+8x⁴y⁵z²+6x⁵y⁵z²+10x⁶y⁵z²+9x⁷y⁵z²+3x⁸y⁵z²+5x⁹y⁵z²+10x¹⁰y⁵z²+3xy⁶z²+10x²y⁶z²+9x³y⁶z²+2x⁴y⁶z²+10x⁵y⁶z²+2x⁶y⁶z²+3x⁷y⁶z²+3x⁸y⁶z²+99y⁶z²+9x¹⁰y⁶z²+8y²z²+6xy⁷z²+6x²y⁷z²+5x³y⁷z²+10x⁴y⁷z²+2x⁵y⁷z²+3x⁶y⁷z²+8x⁸y⁷z²+6x⁹y⁷z²+3x¹⁰y⁷z²+2y⁸z²+10xy⁸z²+10x³y⁸z²+7x⁴y⁸z²+3x⁵y⁸z²+10x⁶y⁸z²+8x⁷y⁸z²+6x⁸y⁸z²+4x⁹y⁸z²+2x¹⁰y⁸z²+5y⁹z²+8xy⁹z²+2x²y⁹z²+9x³y⁹z²+4x⁴y⁹z²+6x⁵y⁹z²+5x⁷y⁹z²+5x⁸y⁹z²+6x⁹y⁹z²+4x¹⁰y⁹z²+3xy¹⁰z²+2x³y¹⁰z²+6x⁴y¹⁰z²+9x⁵y¹⁰z²+3x⁶y¹⁰z²+6x⁷y¹⁰z²+4x⁹y¹⁰z²+7x¹⁰y¹⁰z²+2x²z³+4x⁴z³+3x⁶z³+8x⁷z³+3x⁸z³+3xyz³+5x²yz³+8x⁴yz³+7x⁵yz³+6x⁶yz³+3x⁷yz³z+4x⁸yz³+10x⁹yz³+3x¹⁰yz³+y²z³+4xy²z³+6x²y²z³+2x⁴y²z³+4x⁵y²z³+9x⁶y²z³+9x⁷y²z³+x⁸y²z³+4x⁹y²z³+10x¹⁰y²z³+8xy³z³+8x³y³z³+3x⁴y³z³+7x⁵y³z³+3x⁶y³z³+6x⁸y³z³+3x¹⁰y³z³+2y⁴z³+4xy⁴z³+3x²y⁴z³+10x³y⁴z³+9x⁴y⁴z³+2x⁵y⁴z³+x⁸y⁴z³+9x¹⁰y⁴z³+9xy⁵z³+9x²y⁵z³+4x³y⁵z³+9x⁴y⁵z³+4x⁶y⁵z³+8x⁷y⁵z³+4x⁸y⁵z³+2x⁹y⁵z³+7y⁶z³+2xy⁶z³+7x²y⁶z³+6x⁵y⁶z³+8x⁶y⁶z³+6x⁸y⁶z³+5x⁹y⁶z³+4x¹⁰y⁶z³+2y⁷z³+xy⁷z³+6x²y⁷z³+x⁴y⁷z³+8x⁵y⁷z³+3x⁶y⁷z³+5x⁷y⁷z³+x⁸y⁷z³+10x⁹y⁷z³+3x¹⁰y⁷z³+7y⁸z³+4xy⁸z³+3x²y⁸z³+9x⁴y⁸z³+x⁵y⁸z³+8x⁶y⁸z³+6x⁷y⁸z³+3x⁸y⁸z³+2x⁹y⁸z³+2x¹⁰y⁸z³+8xy⁹z³+2x²y⁹z³+6x³y⁹z³+2x⁴y⁹z³+7x⁵y⁹z³+x⁶y⁹z³+6x⁷y⁹z³+2x⁸y⁹z³+7x⁹y⁹z³+8x¹⁰y⁹z³+7xy¹⁰z³+9x²y¹⁰z³+7x⁴y¹⁰z³+8x⁵y¹⁰z³+8x⁶y¹⁰z³+2x⁷y¹⁰z³+x⁹y¹z³+10yz⁴+7x³z⁴+x⁵z⁴+8x⁶z⁴+5x⁷z⁴+5yz⁴+8xyz⁴+3x²yz⁴+3x³yz⁴+8x⁴yz⁴+10x⁶yz⁴+5x⁷yz⁴+10x⁸yz⁴+7x⁹yz⁴+6x¹⁰yz⁴+6xy²z⁴+3x³y²z⁴+10x⁴y²z⁴+9x⁵y²z⁴+8x⁶y²z⁴+x⁷y²z⁴+5x⁸y²z⁴+4x⁹y²z⁴+3x¹⁰y²z⁴+9y³z⁴+7xy³z⁴+9x²y³z⁴+6x³y³z⁴+3x⁴y³z⁴+4x⁵y³z⁴+1x⁷y³z⁴+

10x⁸y³z⁴+9x⁹y³z⁴+2x¹⁰y³z⁴+4xy⁴z⁴+3x²y⁴z⁴+8x³y⁴z⁴+3x⁶y⁴z⁴+4x⁸y⁴z⁴+5x¹⁰y⁴z⁴+6y⁵z⁴+8xy⁵z⁴+5x²y⁵z⁴+2x³y⁵z⁴+7x⁵y⁵z⁴+7x⁶y⁵z⁴+3x⁸y⁵z⁴+3x⁸y⁵z⁴+9x⁹y⁵z⁴+5x¹⁰y⁵z⁴+2y⁶z⁴+xy⁶z⁴+9x²y⁶z⁴+7x⁵y⁶z⁴+4x⁶y⁶z⁴+7x⁷y⁶z⁴+8x⁸y⁶z⁴+5x⁹y⁶z⁴+4x¹⁰y⁶z⁴+8y⁷z⁴+5xy⁷z⁴+3x²y⁷z⁴+10x³y⁷z⁴+8x⁴y⁴z⁴+0x⁵y⁷z⁴+9x⁶y⁷z⁴+8x⁷y⁷z⁴+9x⁸y⁷z⁴+8x⁹y⁷z⁴+x¹⁰y⁷z⁴+8xy⁸z⁴+4x²y⁸z⁴+5x³y⁸z⁴+8x⁵y⁸z⁴+9x⁶y⁸z⁴+4x⁷y⁸z⁴+8x⁸y⁸z⁴+9x⁹y⁸z⁴+5x¹⁰y⁸z⁴+9xy⁹z⁴+9x²y⁹z⁴+9x³y⁹z⁴+10x⁴y⁹z⁴+6x⁵y⁹z⁴+7x⁶y⁹z⁴+3x⁷y⁹z⁴+8x⁸y⁹z⁴+10x⁹y⁹z⁴+xy¹⁰z⁴+5x²y¹⁰z⁴+4x³y¹⁰z⁴+10x⁵y¹⁰z⁴+4x⁶y¹⁰z⁴+9x⁷y¹⁰z⁴+7x⁸y¹⁰z⁴+9x²z⁵+10x⁴z⁵+8x⁵z⁵+4x⁶z⁵+10xyz⁵+8x²yz⁵+9x³yz⁵+9x⁴yz⁵+9x⁵yz⁵+5x⁶yz⁵+10x⁷yz⁵+3x⁸yz⁵+7x⁹y⁵+x¹⁰yz⁵+10y²z⁵+9xy²z⁵+4x²y²z⁵+5x³y²z⁵+4x⁴y²z⁵+x⁶y²z⁵+7x⁷y²z⁵+8x⁸y²z⁵+10x⁹y²z⁵+x¹⁰y²z⁵+10xy³z⁵+4x²y³z⁵+x³y³z⁵+7x⁴y³z⁵+9x⁶y³z⁵+3x⁷y³z⁵+3x⁸y³z⁵+9x⁹y³z⁵+3x¹⁰y³z⁵+5y⁴z⁵+7xy⁴z⁵+8x²y⁴z⁵+9x³y⁴z⁵+4x⁶y⁴z⁵+4x⁷y⁴z⁵+8x⁸y⁴z⁵+3x⁹y⁴z⁵+6x¹⁰y⁴z⁵+2y⁵z⁵+2xy⁵z⁵+5x²y⁵z⁵+4x⁴y⁵z⁵+4x⁶y⁵z⁵+7x⁸y⁵z⁵+5x¹⁰y⁵z⁵+2y⁶z⁵+3xy⁶z⁵+3x²y⁶z⁵+5x³y⁶z⁵+x⁴y⁶z⁵+7x⁶y⁶z⁵+5x⁷y⁶z⁵+4x⁸y⁶z⁵+3x⁹y⁶z⁵+7x¹⁰y⁶z⁵+8xy⁷z⁵+9x²y⁷z⁵+9x³y⁷z⁵+x⁴y⁷z⁵+5x⁵y⁷z⁵+x⁶y⁷z⁵+10x⁷y⁷z⁵+7x⁸y⁷z⁵+2x⁹y⁷z⁵+8x¹⁰y⁷z⁵+7xy⁸z⁵+2x²y⁸z⁵+10x³y⁸z⁵+7x⁴y⁸z⁵+5x⁶y⁸z⁵+4x⁷y⁸z⁵+9x⁸y⁸z⁵+5x⁹y⁸z⁵+10xy⁹z⁵+5x²y⁹z⁵+10x³y⁹z⁵+5x⁴y⁹z⁵+8x⁵y⁹z⁵+4x⁶y⁹z⁵+6x⁷y⁹z⁵+x⁸y⁹z⁵+6xy¹⁰z⁵+2x²y¹⁰z⁵+3x³y¹⁰z⁵+x⁴y¹⁰z⁵+6x⁵y¹⁰z⁵+10x⁶y¹⁰z⁵+x⁷y¹⁰z⁵+8xz⁶+8x³z⁶+8x⁴z⁶+7x⁵z⁶+4yz⁶+xyz⁶+10x²yz⁶+3x³yz⁶+9x⁴yz⁶+6x⁵yz⁶+10y⁶yz⁶+x⁷yz⁶+7x⁸yz⁶+6x⁹yz⁶+7x¹⁰yz⁶+5xy²z⁶+2x²y²z⁶+7x³y²z⁶+3x⁴y²z⁶+x⁵y²z⁶+8x⁷y²z⁶+4x⁸y²z⁶+2x⁹y²z⁶+6x¹⁰y²z⁶+4y³z⁶+6y³z⁶+6xy³z⁶+3x²y³z⁶+8x³y³z⁶+2x⁵y³z⁶+3x⁶y³z⁶+8x⁷y³z⁶+5x⁸y³z⁶+4x⁹y³z⁶+7x¹⁰y³z⁶+2y⁴z⁶+10xy⁴z⁶+x²y⁴z⁶+8x⁴y⁴z⁶+4x⁵y⁴z⁶+4x⁷y⁴z⁶+10x⁸y⁴z⁶+6x⁹y⁴z⁶+6x¹⁰y⁴z⁶+9y⁵z⁶+9xy⁵z⁶+3x²y⁵z⁶+7x³y⁵z⁶+x⁴y⁵z⁶+7x⁵y⁵z⁶+10x⁶y⁵z⁶+4x⁷y⁵z⁶+10x⁸y⁵z⁶+9x⁹y⁵z⁶+8xy⁶z⁶+9x²y⁶z⁶+9x³y⁶z⁶+7x⁴y⁶z⁶+2x⁵y⁶z⁶+5x⁷y⁶z⁶+5x⁸y⁶z⁶+10x⁹y⁶z⁶+5x¹⁰y⁶z⁶+6xy⁷z⁶+2x²y⁷z⁶+8x³y⁷z⁶+3x⁴y⁷z⁶+10x⁵y⁷z⁶+7x⁸y⁷z⁶+2x⁹y⁷z⁶+10xy⁸z⁶+x²y⁸z⁶+6x³y⁸z⁶+2x⁴y⁸z⁶+6x⁵y⁸z⁶+10x⁶y⁸z⁶+x⁷y⁸z⁶+2x⁸y⁸z⁶+3xy⁹z⁶+8x²y⁹z⁶+10x³y⁹z⁶+9x⁴y⁹z⁶+5x⁵y⁹z⁶+6x⁶y⁹z⁶+8x⁷y⁹z⁶+3xy¹⁰z⁶+8x²y¹⁰z⁶+3x³y¹⁰z⁶+8x⁴y¹⁰z⁶+7x⁵y¹⁰z⁶+6x²z⁷+8x³z⁷+6x⁴z⁷+8x²yz⁷+7x³yz⁷+6x⁴yz⁷+10x⁵yz⁷+10x⁶yz⁷+7x⁷yz⁷+10x⁸yz⁷+10x⁹yz⁷+3x¹⁰yz⁷+3y²z⁷+4xy²z⁷+7x²y²z⁷+2x³y²z⁷+x⁴y²z⁷+4x⁵y²z⁷+8x⁶y²z⁷+3x⁸y²z⁷+x⁹y²z⁷+8x¹⁰y²z⁷+2y³z⁷+3xy³z⁷+8x²y³z⁷+x⁴y³z⁷+3x⁵y³z⁷+3x⁶y³z⁷+6x⁷y³z⁷+6x⁸y³z⁷+x⁹y³z⁷+7x¹⁰y³z⁷+3y⁴z⁷+3x²y⁴z⁷+5x⁴y⁴z⁷+7x⁵y⁴z⁷+8x⁶y⁴z⁷+5x⁸y⁴z⁷+4x⁹y⁴z⁷+6x¹⁰y⁴z⁷+8xy⁵z⁷+2x²y⁵z⁷+9x³y⁵z⁷+8x⁴y⁵z⁷+10x⁵y⁵z⁷+7x⁶y⁵z⁷+2x⁸y⁵z⁷+7x⁹y⁵z⁷+7x¹⁰y⁵z⁷+5xy⁶z⁷+2x²y⁶z⁷+5x⁴y⁵z⁷+6x⁵y⁶z⁷+6x⁶y⁶z⁷+10x⁷y⁶z⁷+10x⁸y⁶z⁷+5x⁹y⁶z⁷+10xy⁷z⁷+7x³y⁷z⁷+3x⁴y⁷z⁷+x⁵y⁷z⁷+9x⁶y⁷z⁷+5x⁷y⁷z⁷+3x⁸y⁷z⁷+5xy⁸z⁷+9x²y⁸z⁷+5x³y⁸z⁷+7x⁴y⁸z⁷+5x⁵y⁸z⁷+7x⁶y⁸z⁷+xy⁹z⁷+6x²y⁹z⁷+10x³y⁹z⁷+6x⁴y⁹z⁷+5x⁵y⁹z⁷+3x⁶y⁹z⁷+7xy¹⁰z⁷+5x²y¹⁰z⁷+10x³y¹⁰z⁷+8x⁴y¹⁰z⁷+10x⁵y¹⁰z⁷+4xz⁸+8x²z⁸+8x³z⁸+2yz⁸+4xyz⁸+8x²yz⁸+7x³yz⁸+10x⁴yz⁸+8x⁵yz⁸++7x⁶yz⁸+7x⁷yz⁸+10x⁸yz⁸+7x⁹yz⁸+9x¹⁰yz⁸+2y²z⁸+5xy²z⁸+4x²y²z⁸+x³y²z⁸+6x⁴y²z⁸+8x⁵y²z⁸+7x⁶y²z⁸+3x⁷y²z⁸+7x⁹y²z⁸+8x¹⁰y²z⁸+4y³z⁸+3x²y³z⁸+5x³y³z⁸+4x⁴y³z⁸+8x⁵z⁸+9x⁶y³z⁸+5x⁷y³z⁸+10x⁹y³z⁸+5x¹⁰y³z⁸+
8xy⁴z⁸+10x²y⁴z⁸+2x³y⁴z⁸+7x⁴y⁴z⁸+7x⁵y⁴z⁸+x⁶y⁴z⁸+6x⁷y⁴z⁸+10x⁸y⁴z⁸+9x¹⁰y⁴z⁸+4xy⁵z⁸+2x²y⁵z⁸+7x³y⁵z⁸+x⁴y⁵z⁸+4x⁵y⁵z⁸+x⁶y⁵z⁸+7x⁷y⁵z⁸+8x⁸y⁵z⁸+4x⁹y⁵z⁸+10y⁶z⁸+8x²y⁶z⁸+8x³y⁶z⁸+3x⁴y⁶z⁸+7x⁵y⁶z⁸+4x⁶y⁶z⁸+9x⁷y⁶z⁸+6xy⁷z⁸+9x²y⁷z⁸+10x³y⁷z⁸+2x⁴y⁷z⁸+2x⁵y⁷z⁸+x⁶y⁷z⁸+8x⁷y⁷z⁸+8xy⁸z⁸+5x²y⁸z⁸+8x³y⁸z⁸+x⁴y⁸z⁸+7x⁵y⁸z⁸+9x⁶y⁸z⁸+9xy⁹z⁸+7x³y⁹z⁸+x⁴y⁹z⁸+10x⁵y⁹z⁸+7xy¹⁰z⁸+x²y¹⁰z⁸+6x³y¹⁰z⁸+4x⁴y¹⁰z⁸+8xz⁹+x²z⁹+2yz⁹+3xyz⁹+4x²yz⁹+10x³yz⁹+4x⁴y⁹+7x⁵y⁹+5x⁶yz⁹+10x⁷yz⁹+4x⁸yz⁹+5x⁹yz⁹+8x¹⁰yz⁹+6y²z⁹+xy²z⁹+4x²y²z⁹+7x³y²z⁹+9x⁴y²z⁹+x⁵y²z⁹+6x⁶y²z⁹+10x⁷y²z⁹+9x⁸y²z⁹+10x⁹y²z⁹+3x¹⁰y²z⁹+8xy³z⁹+9x²y³z⁹+x³yz⁹+2x⁴y³z⁹+8x⁵y³z⁹+7x⁶y³z⁹+4x⁷y³z⁹+10x⁸y³z⁹+2x⁹y³z⁹+9x¹⁰y³z⁹+2xy⁴z⁹+6x²y⁴z⁹+9x⁴y⁴z⁹+8x⁵y⁴z⁹+10x⁶y⁴z⁹+5x⁷y⁴z⁹+9x⁸y⁴z⁹+10xy⁵z⁹+6x²y⁵z⁹+4x³y⁵z⁹+2x⁴y⁵z⁹+5x⁵y⁵z⁹+4x⁷y⁵z⁹+7x⁸y⁵z⁹+8xy⁶z⁹+10x²y⁶z⁹+6x³y⁶z⁹+6x⁵y⁶z⁹+2x⁶y⁶z⁹+6x⁷y⁶z⁹+8xy⁷z⁹+5x²y⁷z⁹+6x³y⁷z⁹+x⁴y⁷z⁹+9x⁵y⁷z⁹+9x⁶y⁷z⁹+2xy⁸z⁹+x²y⁸z⁹+7x³y⁸z⁹+6x⁵y⁸z⁹+4xy⁹z⁹+3x²y⁹z⁹+8x³y⁹z⁹+x⁴y⁹z⁹+4xy¹⁰z⁹+2x²y¹⁰z⁹+x³y¹⁰z⁹+3z¹⁰+2xz¹⁰+6x¹⁰z¹⁰+yz¹⁰+3+yz¹⁰+4x²yz¹⁰+8x³yz¹⁰+5x⁴yz¹⁰+10x⁵yz¹⁰+4x⁶yz¹⁰+8x⁷yz¹⁰+2x⁸yz¹+4x⁹yz¹⁰+3x¹⁰yz¹⁰+7xy²z¹⁰+10x²y²z¹⁰+x³y²z¹⁰+8x⁴y²z¹⁰+10x⁵y²z¹⁰+5x⁶y²z¹⁰+3x⁷y²z¹⁰+4x⁸y²z¹⁰+3x⁹y²z¹⁰+4xy³z¹⁰+10x²y³z¹⁰+8x³y³z¹⁰+9x⁴y³z¹⁰+8x⁵y³z¹⁰+4x⁶y³z¹⁰+5x⁷y³z¹⁰+x⁸y³z¹⁰+9y³z¹⁰+6xy⁴z¹⁰+2x²y⁴z¹⁰+2x³y⁴z¹⁰+6x⁴y⁴z¹⁰+5x⁵y⁴z¹⁰+6x⁶y⁴z¹⁰+2x⁸y⁴z¹⁰+5xy⁵z¹⁰+x²y⁵z¹⁰+6x⁴y⁵z¹⁰+7x⁵y⁵z¹⁰+6x⁶y⁵z¹⁰+4x⁷y⁵z¹⁰+7xy⁶z¹⁰+2x²y⁶z¹⁰+7x³y⁶z¹⁰+8x⁴y⁶z¹⁰+10x⁵y⁶z¹⁰+6x⁶y⁶z¹⁰+4xy⁷z¹⁰+8x²y⁷z¹⁰+9x³y⁷z¹⁰+5x⁴y⁷z¹⁰+3x⁵y⁷z¹⁰+9xy⁸z¹⁰+10x²y⁸z¹⁰+4z³y⁸z¹⁰+6x⁴y⁸z¹⁰+2x²y⁹z¹⁰+2x²y⁹z¹⁰+3x³y⁹z¹⁰+5y¹⁰z¹⁰+6xy¹⁰z¹⁰+4x²y¹⁰z¹⁰

1. A method for performing, in a single round of communication and by a distributed computational system, Secure MultiParty Computation (SMPC) of an arithmetic function ƒ: [symbol] ₚ^{k}→ [symbol] ₚ represented as a multivariate polynomial over secret shares for a user, comprising the steps of:
a. sharing secrets among participants being distributed computerized systems, using multiplicative shares, the product of which is the secret, or additive shares, that sum up to the secret by partitioning secrets to sums or products of random elements of the field;
b. implementing sequences of additions of secrets locally by addition of local shares or sequences of multiplications of secrets locally by multiplication of local shares;
c. separately evaluating the monomials of ƒ by said participants; and
d. adding said monomials to obtain secret shares of ƒ.

2. A method according to claim 1, wherein two sets of participants are used by a dealer to securely outsource a computation of an arithmetic stream by:
a. providing a first set of participants consists of n₁ M.parties, that locally handle sequences of multiplications;
b. providing a second set consists of n₂ A.parties that locally handle sequences of additions;
c. switching from sequences of multiplications to sequences of additions and vice versa without decrypting the information;
d. eliminating the previous sets whenever there is a switch between sequences of multiplications to sequences of additions.

3. A method for performing, by a distributed computational system, Secure MultiParty Computation (SMPC) of a function ƒ: [symbol] ^{k}→ [symbol] over k non-zero elements S=(s₁, . . . , sₖ)∈ [symbol] ^{k}, where the minimal multivariate polynomial representation of ƒ is
ƒ(x₁, . . . ,xₖ)= [symbol] l₀·x₁^{l}^{₁} . . . xₖ^{l}^{ₖ}, [symbol] ={0,1, . . . }^{k+1}
over secret shares for a user, comprising the steps of:
a. providing k non-zero elements S=(s₁, . . . , sₖ)∈ [symbol] ^{k} of said user;
b. providing n honest-but-curious participants, [symbol] ⁽¹⁾, . . . , [symbol] ⁽ⁿ⁾ belonging to said distributed computational system and having a private connection channel with said n honest-but-curious participants, [symbol] ⁽¹⁾, . . . , [symbol] ⁽ⁿ⁾;
c. for sⱼ, 1≤j≤k, performing mult.-random-split of sⱼ to multiplicative shares, mᵢⱼ, such that sⱼ=Πᵢ₌₁ⁿ mᵢⱼ;
d. distributing mᵢⱼ to [symbol] ⁽ⁱ⁾;
e. evaluating the monomials of ƒ separately by said participants and adding said monomials to obtain secret shares of ƒ(s₁, . . . , sₖ), where for l∈ [symbol] , the l'th monomial is l₀·x₁^{l}^{₁} . . . xₖ^{l}^{ₖ}; and
f. for each l, calculating additive shares such Uᵢ of the l'th monomial of ƒ evaluated on S, such that each participant [symbol] ⁽ⁱ⁾ obtains such Uᵢ for each of the monomials of ƒ.

4. A method for performing, by a distributed computational system, Secure MultiParty Computation (SMPC) of a p-bounded arithmetic function ƒ: [symbol] ₚ^{k}→ [symbol] ₚ over k elements S=(s₁, . . . , sₖ)∈ [symbol] ₚ^{k}, where the minimal multivariate polynomial representation of ƒ is
ƒ(x₁, . . . ,xₖ)= [symbol] l₀·x₁^{l}^{₁} . . . xₖ^{l}^{ₖ}, [symbol] ={0, . . . ,p−1}^{k+1}
over secret shares for a user, comprising the steps of:
a. providing k elements S=(s₁, . . . , sₖ)∈ [symbol] ₚ^{k} of said user;
b. providing n honest-but-curious participants, [symbol] ⁽¹⁾, . . . , [symbol] ⁽ⁿ⁾ belonging to said distributed computational system and having a private connection channel with said n honest-but-curious participants, [symbol] ⁽¹⁾, . . . , [symbol] ₍ₙ₎;
c. for sⱼ, 1≤j≤k, performing mult.-random-split of sⱼ to multiplicative shares, mᵢⱼ, such that sⱼ=Πᵢ₌₁ⁿ mᵢⱼ;
d. distributing mᵢⱼ to [symbol] ⁽ⁱ⁾;
e. evaluating the monomials of ƒ separately by said participants and adding said monomials to obtain secret shares of ƒ(s₁, . . . , sₖ), where for l∈ [symbol] , the l'th monomial is l₀·x₁^{l}^{₁} . . . xₖ^{l}^{ₖ}; and
f. for each l, calculating additive shares such Uᵢ of the l'th monomial of ƒ evaluated on S, such that each participant [symbol] ⁽ⁱ⁾ obtains such Uᵢ for each of the monomials of ƒ.

5. A method according to claim 3, wherein the l'th monomial is evaluated by:
a. sending l to the participants;
b. performing matrix-random-split of 1 to C∈Mₙ( [symbol] ₚ) according to the following steps:
b.1) perform add.-random-split of 1∈ [symbol] ₚ to γ₁+ . . . +γₙ.
for 1≤i≤n:
b.2) choose uniformly at random n−1 non-zero elements of [symbol] ₚ, cᵢⱼ, for 1≤j≤n, j≠i;
b.3) set cᵢᵢ=γᵢ/δ where δ=c_{i,1} . . . c_{i,j-1}·c_{i,j+1} . . . c_{i,n};
b.4) distribute to each [symbol] ⁽ⁱ⁾ the i'th column [C]ᵢ of C., where C=(cᵢⱼ)_{i,j=1}ⁿ∈Mₙ( [symbol] ₚ).
b.5) each [symbol] ⁽ⁱ⁾ computes the alpha vector αᵢ of participant [symbol] ⁽ⁱ⁾;
b.6) for 1≤i≤n, each of the participants sends the i'th entry of the alpha vector, computed in the previous stage, to [symbol] ⁽ⁱ⁾; and
b.7) each of the participants multiplies the values received in the previous stage and computes:
Uᵢ=l₀·(α₁)ᵢ· . . . ·(αₙ)ᵢ.

6. A method according to claim 3, further comprising adding additive shares of two functions that ƒ₁ and ƒ₂ evaluated on S, held by the participants to obtain additive shares of ƒ₁(S)+ƒ₂(S).

7. A method according to claim 3, further comprising calculating a linear combination if additive shares of an arbitrary number of functions ƒ₁, . . . , ƒ_{d} evaluated on S, to obtain additive shares of ƒ₁(S)+ƒ₂(S)+ . . . +ƒ_{d}(S).

8. A method according to claim 3, wherein the SMPC of the product ƒ(S)·l₀·s₁^{l}^{₁} . . . sₖ^{l}^{ₖ} for a given l is performed by generating a matrix-random-split of ƒ(S) using the additive shares of ƒ(S) held by the participants.

9. A method according to claim 3, wherein additive shares of the product ƒ(S)·l₀·s₁^{l}^{₁} . . . sₖ^{l}^{ₖ} are held by the participants, by:
a. allowing each participant [symbol] ⁽ⁱ⁾ to perform mult.-random-split of γᵢ to cᵢ₁· . . . ·cᵢₙ, where γ₁, . . . , γₙ are the additive shares of ƒ(S) held by the participants at the end of the evaluation procedure and the cᵢⱼ's constitute a matrix-random-split of ƒ(S);
b. allowing each participant [symbol] ⁽ⁱ⁾ to distribute the multiplicative shares of its additive share of ƒ(S) to the other participants in a way that each participant [symbol] ⁽ⁱ⁾ receives the i'th column of C.

10. A method according to claim 3, wherein switching from multiplicative shares of sⱼ to additive shares of sⱼ is implemented using evaluation to perform SMPC of the function ƒ(x₁, . . . , xₖ)=sⱼ and switching from additive shares of sⱼ to multiplicative shares of sⱼ is implemented e for computing a product ƒ(S)·l₀·s₁^{l}^{₁} . . . sₖ^{l}^{ₖ}.

11. A method according to claim 4, wherein some of the secret shares are zero.

12. A method according to claim 1, wherein the number of participants is extended to n₁ M.parties+n₂ A.parties (n₁, n₂≥2) by:
a. taking n₁−1 random non-zero elements of the field, x₁, . . . , xₙ_{₁}₋₁;
computing the xₙ_{₁} that yields Πᵢ₌₁ⁿ^{₁} xᵢ=m; and
b. taking n₂−1 random non-zero elements of the field, x₁, . . . ,xₙ_{₂}₋₁;
computing the xₙ_{₂} that yields Σᵢ₌₁ⁿ^{₂} xᵢ=m.

13. A method according to claim 1, wherein additive shares of the secret shared data are produced from multiplicative shares of the secret shared data by shifting information from n₁ M.parties to n₂ A.parties according to the following steps:
a. if n₁ M.parties, [symbol] ⁽ⁱ⁾, 1≤i≤n₁, hold n₁ multiplicative shares, xᵢ, of an element m, to achieve n₂ additive shares of m held by n₂ A.parties, splitting x₁ to n₂ additive shares bⱼ, 1≤j≤n₂ by [symbol] ⁽¹⁾ add.-random;
b. sending each bⱼ to the j'th A.party;
c. sending xᵢ to each of the A.parties by the rest of the M.parties, [symbol] ⁽ⁱ⁾, 2≤i≤n₁;
d. eliminating the M.parties; and
e. multiplying the received values by the A.parties, to obtain additive shares of m. where,
m=Πᵢ₌₁ⁿ^{₁}xᵢ=x₁·Πᵢ₌₂ⁿ^{₁}xᵢ=(Σⱼ₌₁ⁿ^{₂}bⱼ)·Πᵢ₌₂ⁿ^{₁}xᵢ=Σⱼ₌₁ⁿ^{₂}(bⱼ·Πᵢ₌₂ⁿ^{₁}xᵢ).

14. A method according to claim 1, wherein multiplicative shares of the secret shared data are produced from additive shares of the secret shared data by shifting information from n₂ A.parties to nᵢ M.parties according to the following steps:
a. if n₂ A.parties, [symbol] ⁽ⁱ⁾, 1≤i≤n₂, hold n₂ additive shares, xᵢ, of an element m, obtain n₁ multiplicative shares of m held by n₁ M.parties, splitting 1 to n₁ multiplicative shares by mult.-random;
b. sending n₁−1 M.parties one (distinct) multiplicative share of 1;
c. sending the last share of 1 to all of the A.parties;
d. multiplying, by each of the A.parties, the multiplicative share of 1 received by its additive share of m;
e. sending the product to the last M.party;
f. eliminating the A.parties; and
g. adding the values received by the last M.party, such that the M.parties hold multiplicative shares of m.

15. A method according to claim 1, wherein Secure MultiParty Computation (SMPC) of Boolean circuits are computed by working in [symbol] ₂.

16. A method according to claim 3, wherein Secure MultiParty Computation (SMPC) of arithmetic functions over inputs held by k users [symbol] ⁽¹⁾, . . . , [symbol] ^{(k)}, each of whom is holding a set of secret values in [symbol] ₚ, is performed by the following steps:
a. each of the users distributes shares of his secrets;
b. one of the users sends the relevant information to the other participants;
c. the participants send their outputs to all of the users; and
d. each of the users obtains the result of evaluating ƒ over the entire set of secrets by adding said outputs.

17. A method according to claim 2, wherein arithmetic streams are secured by performing, at each stage of computation, both addition and multiplication operations that yield the same result that are obtained by one of said operations.

18. A method according to claim 3, wherein if the information held by the user is m=(m₁, . . . ,mₙ)∈ [symbol] ₚⁿ, an arithmetic function ƒ is secured by the following steps:
a. taking redundant copies of each (or some) of the mᵢ's;
b. taking redundant variables that equal 1∈ [symbol] ₚ,
c. taking redundant variables that equal 0∈ [symbol] ₚ;
d. permute them all to obtain m′=(m′₁, . . . , m′ᵣ) which contains the information began with, along the added redundancy; and
e. evaluating ƒ: [symbol] ₚⁿ→ [symbol] ₚ over m by taking a suitable ƒ′: [symbol] ₚ^{r}→ [symbol] ₚ and evaluating ƒ′ over m′ such that ƒ(m)=ƒ′(m′), where ƒ(m)= [symbol] aᵢ·Aᵢ, αᵢ∈ [symbol] ₚ, and Aᵢ is the i'th monomial.

19. A method according to claim 1, further comprising detecting incorrect outputs caused by malicious participants by repeating the same computations while using different sets of participants.

20. A method according to claim 1, further comprising detecting incorrect outputs caused by malicious participants by computing different representations of the same function.

21. A method according to claim 1, further comprising detecting incorrect outputs caused by malicious participants by computing the same circuit several times using the same n participants with different randomization in each computation and different representations of the same circuit in each iteration.

22. A method according to claim 3, wherein functions are evaluated over inputs being held by all of the participant.

23. A method according to claim 3, wherein the user is one of the participants.

24. A computerized system for performing, in a single round of communication and by a distributed computational system, Secure MultiParty Computation (SMPC) of an arithmetic function ƒ: [symbol] ₚ^{k}→ [symbol] ₚ represented as a multivariate polynomial over secret shares for a user, comprising:
a. at least one processor, adapted to:
a.1) share secrets among participants being distributed interconnected computerized systems, using multiplicative shares, the product of which is the secret, or additive shares, that sum up to the secret by partitioning secrets to sums or products of random elements of the field;
a.2) implementing sequences of additions of secrets locally by addition of local shares or sequences of multiplications of secrets locally by multiplication of local shares; and
a.3) evaluating the monomials of ƒ by said participants separately; and
a.4) add said monomials to obtain secret shares of ƒ; and
b. a plurality of private connection channels between each participant and said user, for securely exchanging encrypted data consisting of a combination of secret shares.

25. A method according to claim 4, wherein the l'th monomial is evaluated by:
c. sending l to the participants;
d. performing matrix-random-split of 1 to C∈Mₙ( [symbol] ₚ) according to the following steps:
b.1) perform add.-random-split of 1∈ [symbol] ₚ to γ₁+ . . . +γₙ.
for 1≤i≤n:
b.2) choose uniformly at random n−1 non-zero elements of [symbol] ₚ, cᵢⱼ, for 1≤j≤n, j≠i;
b.3) set cᵢᵢ=γᵢ/δ where δ=c_{i,1} . . . c_{i,j-1}·c_{i,j+1} . . . c_{i,n};
b.4) distribute to each [symbol] ⁽ⁱ⁾ the i'th column [C]ᵢ of C., where C=(cᵢⱼ)_{i,j=1}ⁿ∈Mₙ( [symbol] ₚ).
b.5) each [symbol] ⁽ⁱ⁾ computes the alpha vector αᵢ of participant [symbol] ⁽ⁱ⁾;
b.6) for 1≤i≤n, each of the participants sends the i'th entry of the alpha vector, computed in the previous stage, to [symbol] ⁽ⁱ⁾; and
b.7) each of the participants multiplies the values received in the previous stage and computes:
Uᵢ=l₀·(α₁)ᵢ· . . . ·(αₙ)ᵢ.

26. A method according to claim 4, further comprising adding additive shares of two functions that ƒ₁ and ƒ₂ evaluated on S, held by the participants to obtain additive shares of ƒ₁(S)+ƒ₂(S).

27. A method according to claim 4, further comprising calculating a linear combination if additive shares of an arbitrary number of functions ƒ₁, . . . , ƒ_{d} evaluated on S, to obtain additive shares of ƒ₁(S)+ƒ₂(S)+ . . . +ƒ_{d}(S).

28. A method according to claim 4, wherein the SMPC of the product ƒ(S)·l₀·s₁^{l}^{₁} . . . sₖ^{l}^{ₖ} for a given l is performed by generating a matrix-random-split of ƒ(S) using the additive shares of ƒ(S) held by the participants.

29. A method according to claim 4, wherein additive shares of the product ƒ(S)·l₀·s₁^{l}^{₁} . . . sₖ^{l}^{ₖ} are held by the participants, by:
c. allowing each participant [symbol] ⁽ⁱ⁾ to perform mult.-random-split of γᵢ to cᵢ₁· . . . ·cᵢₙ, where γ₁, . . . , γₙ are the additive shares of ƒ(S) held by the participants at the end of the evaluation procedure and the cᵢⱼ's constitute a matrix-random-split of ƒ(S);
d. allowing each participant [symbol] ⁽ⁱ⁾ to distribute the multiplicative shares of its additive share of ƒ(S) to the other participants in a way that each participant [symbol] ⁽ⁱ⁾ receives the i'th column of C.

30. A method according to claim 4, wherein switching from multiplicative shares of sⱼ to additive shares of sⱼ is implemented using evaluation to perform SMPC of the function ƒ(x₁, . . . , xₖ)=sand switching from additive shares of sⱼ to multiplicative shares of sⱼ is implemented e for computing a product ƒ(S)·l₀·s₁^{l}^{₁} . . . sₖ^{l}^{ₖ}.

31. A method according to claim 2, wherein the number of participants is extended to n₁ M.parties+n₂ A.parties (n₁, n₂≥2) by:
c. taking n₁−1 random non-zero elements of the field, x₁, . . . , xₙ_{₁}₋₁;
computing the xₙ_{₁} that yields Πᵢ₌₁ⁿ^{₁} xᵢ=m; and
d. taking n₂−1 random non-zero elements of the field, x₁, . . . , xₙ_{₂}₋₁;
computing the xₙ_{₂} that yields Σᵢ₌₁ⁿ^{₂} xᵢ=m.

32. A method according to claim 2, wherein additive shares of the secret shared data are produced from multiplicative shares of the secret shared data by shifting information from n₁ M.parties to n₂ A.parties according to the following steps:
f. if n₁ M.parties, [symbol] ⁽ⁱ⁾, 1≤i≤n₁, hold n₁ multiplicative shares, xᵢ, of an element m, to achieve n₂ additive shares of m held by n₂ A.parties, splitting x₁ to n₂ additive shares b_{b}, 1≤j≤n₂ by [symbol] ⁽¹⁾ add.-random;
g. sending each bⱼ to the j'th A.party;
h. sending xᵢ to each of the A.parties by the rest of the M.parties, [symbol] ⁽ⁱ⁾, 2≤i≤n₁;
i. eliminating the M.parties; and
j. multiplying the received values by the A.parties, to obtain additive shares of m. where,
m=Πᵢ₌₁ⁿ^{₁}xᵢ=x₁·Πᵢ₌₂ⁿ^{₁}xᵢ=(Σⱼ₌₁ⁿ^{₂}bⱼ)·Πᵢ₌₂ⁿ^{₁}xᵢ=Σⱼ₌₁ⁿ^{₂}(bⱼ·Πᵢ₌₂ⁿ^{₁}xᵢ).

33. A method according to claim 2, wherein multiplicative shares of the secret shared data are produced from additive shares of the secret shared data by shifting information from n₂ A.parties to n₁ M.parties according to the following steps:
h. if n₂ A.parties, [symbol] ⁽ⁱ⁾, 1≤i≤n₂, hold n₂ additive shares, xᵢ, of an element m, obtain n₁ multiplicative shares of m held by n₁ M.parties, splitting 1 to n₁ multiplicative shares by mult.-random;
i. sending n₁−1 M.parties one (distinct) multiplicative share of 1;
j. sending the last share of 1 to all of the A.parties;
k. multiplying, by each of the A.parties, the multiplicative share of 1 received by its additive share of m;
l. sending the product to the last M.party;
m. eliminating the A.parties; and
n. adding the values received by the last M.party, such that the M.parties hold multiplicative shares of m.

34. A method according to claim 2, wherein Secure MultiParty Computation (SMPC) of Boolean circuits are computed by working in [symbol] ₂.

35. A method according to claim 4, wherein Secure MultiParty Computation (SMPC) of arithmetic functions over inputs held by k users [symbol] ⁽¹⁾, . . . , [symbol] ^{(k)}, each of whom is holding a set of secret values in [symbol] ₚ, is performed by the following steps:
e. each of the users distributes shares of his secrets;
f. one of the users sends the relevant information to the other participants;
g. the participants send their outputs to all of the users; and
h. each of the users obtains the result of evaluating ƒ over the entire set of secrets by adding said outputs.

36. A method according to claim 4, wherein if the information held by the user is m=(m₁, . . . , mₙ)∈ [symbol] ₚⁿ, an arithmetic function ƒ is secured by the following steps:
f. taking redundant copies of each (or some) of the mᵢ's;
g. taking redundant variables that equal 1∈ [symbol] ₚ,
h. taking redundant variables that equal 0∈ [symbol] ₚ;
i. permute them all to obtain m′=(m′₁, . . . , m′ᵣ) which contains the information began with, along the added redundancy; and
j. evaluating ƒ: [symbol] ₚⁿ→ [symbol] ₚ over m by taking a suitable ƒ′: [symbol] ₚ^{r}→ [symbol] ₚ and evaluating ƒ′ over m′ such that ƒ(m)=ƒ′(m′), where ƒ(m)= [symbol] aᵢ·Aᵢ, aᵢ∈ [symbol] ₚ, and Aᵢ is the i'th monomial.

37. A method according to claim 4, wherein functions are evaluated over inputs being held by all of the participants.

38. A method according to claim 4, wherein the user is one of the participants.
